(19) United States
(12) Patent Application Publication
(10) Pub. No.: US 2026/0243040 A1
(43) Pub. Date: Aug. 20, 2026

(54) ROBOTIC SYSTEM TO INSTALL SOLAR ARRAY

(71) Applicant: Pegasus Solar Inc., Richmond, CA (US)

(72) Inventors: Erich Kai Stephan, Richmond, CA (US); Ian Wogan, Richmond, CA (US)

(21) Appl. No.: 19/542,525

(22) Filed: Feb. 17, 2026

Related U.S. Application Data
(60) Provisional application No. 63/758,927, filed on Feb. 14, 2025.

(51) Int. Cl. E02D 7/16; E02D 13/04; H02S 20/30; H02S 99/00

(52) U.S. Cl. CPC E02D 7/165; E02D 13/04; H02S 20/30; H02S 99/00

(57) ABSTRACT

A robotic system for driving micropiles into a terrain is disclosed. The system may include a chassis, a micropile hoper mounted to the chassis, and a retractable driving arm. The retractable driving arm may be of an extendable length and mounted to the chassis by at least one articulating connection. The system may further include a drive unit mounted to the driving arm, in which the drive unit drives a micropile into the terrain. The system may further include a micropile feeder that feeds the micropile from the micropile hopper to a position under the drive unit. The system may further include a power unit that powers the drive unit and the driving arm.

### CROSS-REFERENCE TO RELATED APPLICATIONS

The present patent application claims the priority benefit of U.S. provisional patent application No. 63/758,927 filed Feb. 14, 2025, the disclosure of which is incorporated by reference herein.

### BACKGROUND OF THE INVENTION

### 1. Field of the Art

The present invention generally relates to solar module installing systems and more specifically using a robotic system to install solar modules.

### 2. Description of the Related Art

Currently, solar modules are often installed manually, which is costly and time consuming.

### SUMMARY OF THE CLAIMED INVENTION

Embodiments of the present invention may include a robotic system for driving micropiles into a terrain. The system may include a chassis, a micropile hoper mounted to the chassis, and a retractable driving arm. The retractable driving arm may be of an extendable length and mounted to the chassis by at least one articulating connection. The system may further include a drive unit mounted to the driving arm, in which the drive unit drives a micropile into the terrain. The system may further include a micropile feeder that feeds the micropile from the micropile hopper to a position under the drive unit. The system may further include a power unit that powers the drive unit and the driving arm.

Embodiments of the present invention may include a method for transporting a micropile by a robotic system. The method may include drawing a horizontal stack of micropiles from a micropile hopper by a micropile feeder. The method may further include reorienting one of the micropiles from a horizontal position to a vertical position under a drive unit by the micropile feeder. The method may further include driving the micropile into the terrain by the drive unit by the robotic system.

### BRIEF DESCRIPTION OF THE DRAWINGS

FIG. 1 is an isometric view of a micropile robot in a collapsed position.

FIG. 2 is an isometric view of a micropile robot in a collapsed position.

FIG. 3 is an isometric view of a chassis.

FIG. 4 is an isometric view of components of a micropile installation assembly.

FIG. 5 is an isometric view of a cargo bed assembly.

FIG. 6 is an isometric view of a mule robot in a collapsed state.

FIG. 7 is an isometric view of a mule robot in an extended state.

FIG. 8 is an isometric view of two mule robots.

FIG. 9 is an isometric view of a crate.

FIG. 10 is an isometric view of a micropile robot and a crate.

FIG. 11 is an isometric view of a micropile robot with a plurality of micropiles.

FIG. 12 is an isometric view of a micropile robot with a micropile hopper.

FIG. 13 is an isometric view of a micropile robot with a micropile hopper.

FIG. 14 is an isometric view of a micropile robot with a retractable driving arm.

FIG. 15 is a side view of a micropile robot with a retractable driving arm.

FIG. 16 is a front view of a micropile robot with a retractable driving arm.

FIG. 17 is an isometric view of a micropile robot with a retractable driving arm.

FIG. 18 is an isometric view of a micropile robot.

FIG. 19 is an isometric view of an exemplar installation sequence of a micropile column.

FIG. 20 is an isometric view of an exemplar installation sequence of a micropile column.

FIG. 21 is an isometric view of an exemplar installation sequence of a micropile column.

FIG. 22 is an isometric view of a micropile column.

FIG. 23 is an isometric view of an exemplar installation sequence of a micropile column.

FIG. 24 is an isometric view of end-swivel bracket assemblies and mid-swivel bracket assemblies.

FIG. 25 is an underside isometric view of a solar module.

FIG. 26 is an isometric view of a plurality of solar modules.

FIG. 27 is an isometric view of solar modules.

FIG. 28 is a close-up isometric view of a swivel bracket assembly.

FIG. 29 is a close-up isometric view of a swivel bracket assembly.

FIG. 30 is a side view of a crimp tube.

FIG. 31 is a side view of a crimp tube.

FIG. 32 is an isometric view illustrating an exemplar installation sequence of a micropile column.

FIG. 33 is an isometric view of a solar module array.

FIG. 34 is a top view of an exemplar installation sequence of four solar module arrays.

FIG. 35 is a top view of an exemplar installation sequence of four solar module arrays.

FIG. 36 is a top view of an exemplar installation sequence of four solar module arrays.

FIG. 37 is an isometric view of a solar module array.

FIG. 38 is an isometric view of a solar module array.

FIG. 39 is a top view of a plurality of solar module arrays.

FIG. 40 is a top view of a plurality of solar module arrays.

### DETAILED DESCRIPTION

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure.

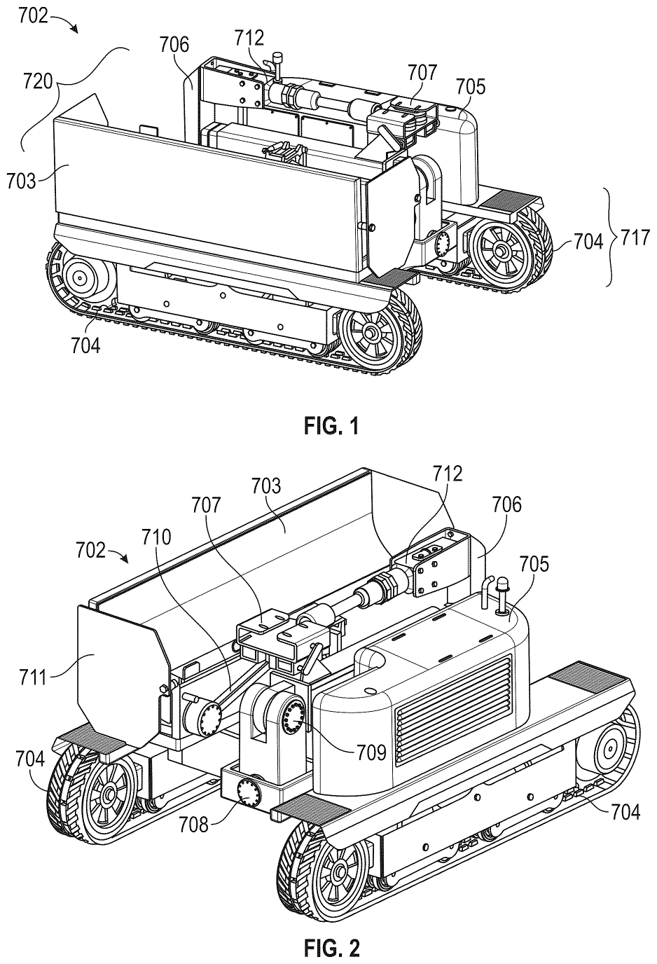

FIGS. 1 and 2 illustrate the micropile robot 702 in a collapsed position, highlighting the primary components and their arrangement, and representing one example embodiment of the present invention. The micropile robot 702 is designed for the efficient installation of micropiles, which are small-diameter, deep foundation elements used in construction. The chassis 717 functions as the structural framework of the micropile robot 702, offering support and housing for various components. The chassis 717 is equipped with treads 704, which facilitate mobility across different terrains. The treads 704 are constructed from durable materials, ensuring stability and traction, which are important for the robot's operation in rugged environments. Mounted on the chassis 717 is the micropile installation assembly 720, which includes several important components. The micropile hopper 703 serves as a storage unit for micropiles 200, enabling the micropile robot 702 to carry multiple micropiles 200 for installation. This feature enhances the robot's efficiency by reducing the need for frequent reloading. The power unit 705 provides the necessary energy to operate the robot. The power unit can be a diesel hydraulic power unit, a diesel electric power unit, or a battery, depending on the operational requirements. This flexibility allows the robot to adapt to various power sources, making the robot versatile for different construction sites.

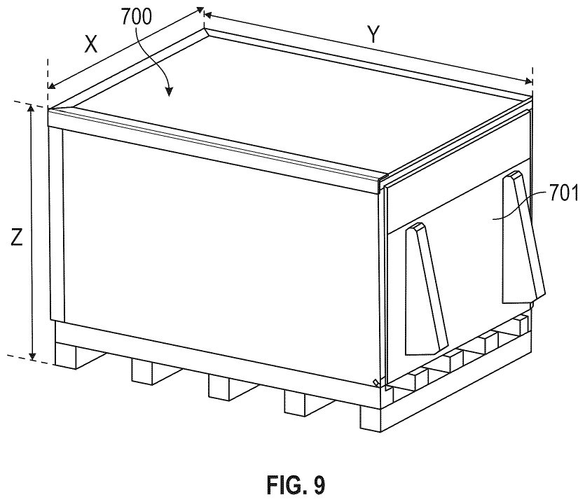

The retractable driving arm 706 is designed to extend and retract for ease of transport. The retractable driving arm 706 may have a micropile drive unit 712 mounted on a distal end and configured to drive or install a micropile 200 into a terrain 190, by percussive or rotational means or a combination of both. This component works in conjunction with the micropile guide 707, which ensures the accurate alignment and insertion of micropiles 200 into the terrain 190. The micropile drive unit 712 is responsible for driving the micropiles 200 into the terrain 190, utilizing the power supplied by the power unit 705. Overall, the configuration of the micropile robot 702 demonstrates a compact and efficient design, enabling the robot to perform micropile 200 installations with precision and adaptability. When in a collapsed state, the micropile robot 702 may be configured to weigh less than 2500 pounds and fit within a crate 700 (see FIG. 9).

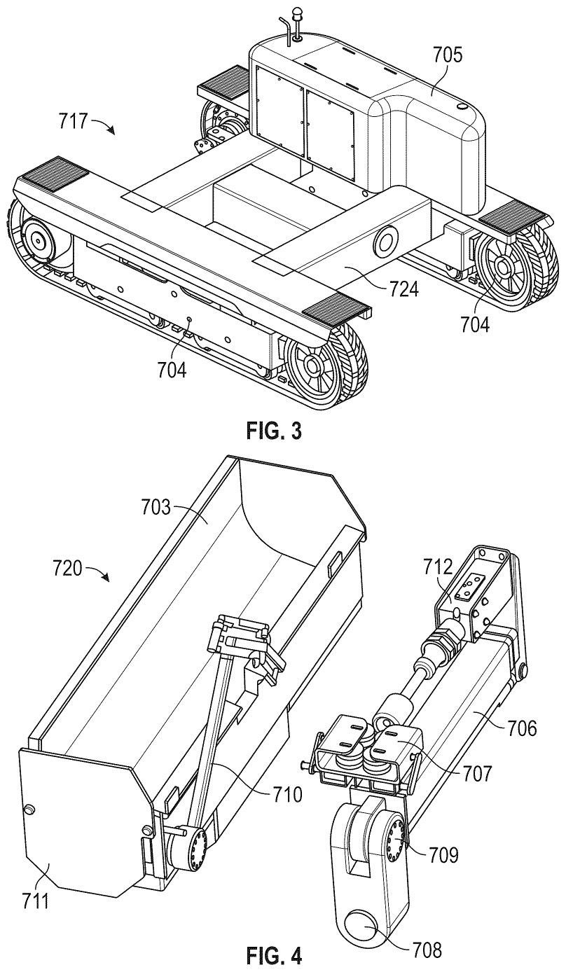

FIG. 3 is an isometric view of a chassis 717 that is configurable into a micropile robot 702 or a mule robot 719, representing one example embodiment of the present invention. The chassis 717 may consist of a one or more treads 704 connected by a chassis frame 724, with a power unit 705 on one of the treads 704. In other embodiments, the power unit 705 may be positioned between a pair of treads 704 and integrated into the chassis frame 724. The power unit 705 may be a diesel hydraulic power unit, a diesel electric power unit, or a battery.

In some example embodiments, treads 704 may be constructed from durable materials such as reinforced rubber, steel, or composite polymers, designed to withstand various terrains and environmental conditions. These materials provide the necessary traction and durability to support the movement of the chassis 717 over uneven or rugged surfaces. Treads 704 are engineered to distribute weight evenly, reducing ground pressure and enhancing stability. Common characteristics of treads 704 include high resistance to wear and tear, flexibility to adapt to different ground contours, and the ability to maintain their grip in wet or slippery conditions. Treads may be a flat track as depicted or may be a suspension-based track where the chassis 717 is supported by a plurality of springs and dampers.

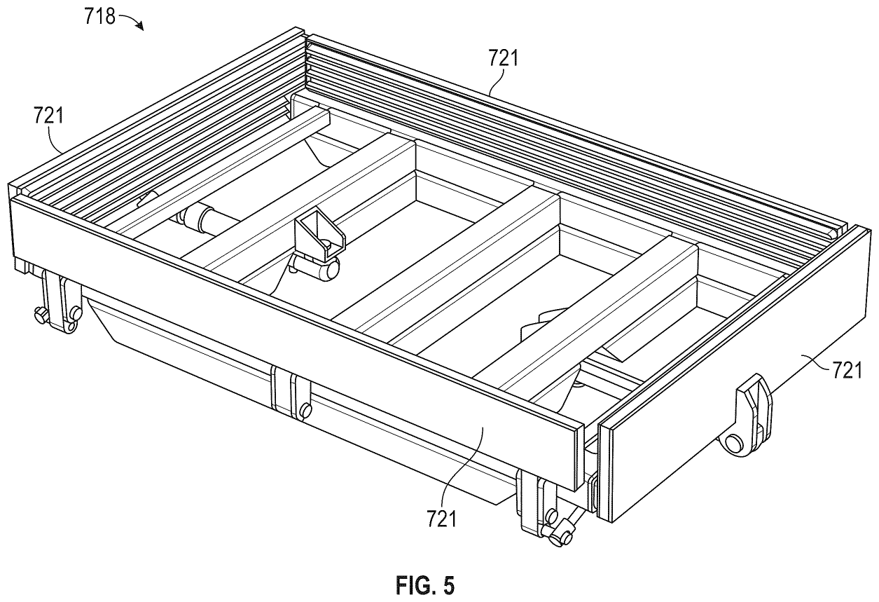

FIG. 4 is an isometric view of a set of components that collectively constitutes a micropile installation assembly 720. The micropile installation assembly 720 may consist of a micropile hopper 703, a micropile feeder 710, and a retractable driving arm 706. The micropile hopper 703 may be configured with a micropile hopper retractable wall 711 on one or more ends that retract and expand to increase the length of the micropile hopper 703. The micropile hopper retractable wall 711 may extend along one or more tracks using one or more actuators and may have a solid or perforated plate on the end to substantially prevent the micropiles from readily dislodging from the micropile hopper 703. The micropile hopper 703 may be configured to loosely or securely hold a plurality of micropiles 200, and may converge or funnel down using one or more sloped, angled, or curved sides so that the micropiles gravitationally traverse to a pick-up location. Micropile feeder 710 may be attached to the micropile hopper 703, or it may be a separate component. The retractable driving arm 706 may consist of a micropile drive unit 712 on one distal end and a drive arm longitudinal pivot 709 and drive arm lateral pivot 708 on an opposite distal end. One or more micropile guides 707 may also be installed on the retractable driving arm 706. The chassis 717 may have a ground clearance of over 8 inches.

FIG. 5 is an isometric view of a cargo bed assembly 718, which may be configurable to be demountably attached to the chassis 717. The cargo bed assembly 718 may consist of one or more extendable cargo walls 721 disposed around the perimeter. An extendable cargo wall 721 may articulate on a hinge point or may be fixed in position. One or more extendable cargo walls 721 may also extend and retract laterally to increase the length and width of the area formed by the four sides of the cargo bed assembly 718. The cargo bed assembly 718 and the micropile drive unit 712 may be configured to temporarily retain a pallet or crate of dimensions up to 2400 mm by 1500 mm, the pallet or crate holding a plurality of solar modules or mounting hardware. The cargo bed assembly 718 may be configured to retain a pallet with a payload of up to 3000 pounds.

The extendable cargo wall 721 is configured to articulate on a hinge point or may be fixed in position, allowing for flexibility in the deployment of the wall. This component can extend and retract laterally, thereby increasing the length and width of the area formed by the four sides of the cargo bed assembly 718. This feature is particularly beneficial for accommodating various sizes of pallets or crates, ensuring that the cargo bed can be adjusted to securely hold different payloads. The extendable cargo wall 721 interacts with other components of the cargo bed assembly 718 to provide a secure and adaptable platform for transporting solar modules or mounting hardware.

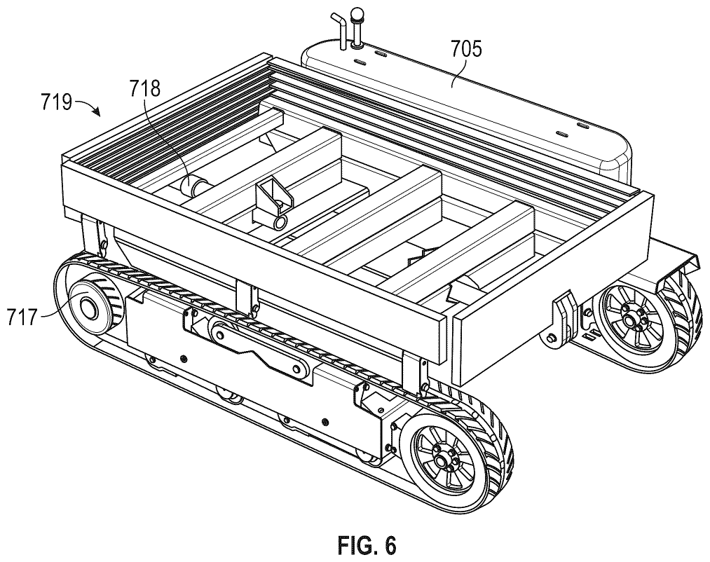

The micropile installation assembly 720 and the cargo bed assembly 718 may be configured to be interchangeably mountable to the chassis 717 in either of two configurations, a micropile robot 702 or a mule robot 719. This interchangeability enables the transformation of the chassis 717 into either a micropile robot 702 (FIG. 1) or a mule robot 719 (FIG. 6), depending on the operational requirements. The cargo bed assembly 718 is thus a versatile component that enhances the adaptability and utility of the overall system, facilitating the efficient transport and installation of solar modules and related components.

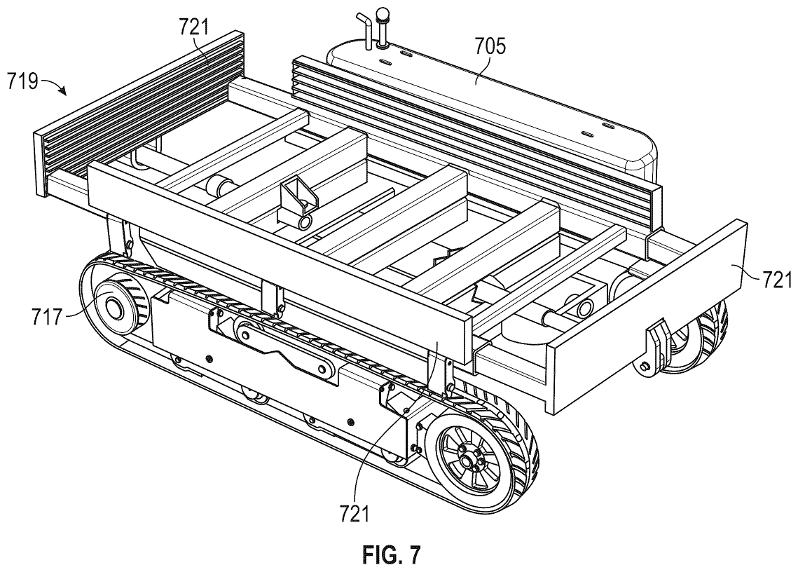

FIGS. 6 and 7 depict isometric views of a mule robot 719 in a collapsed state and an extended state, respectively. The chassis 717 serves as the structural framework, providing support and housing for various components. One or more extendable cargo walls 721 may fold down in order for a pallet, crate, or other cargo support structure to be loaded laterally onto the bed of the mule robot 719 without interference from an extendable cargo wall 721.

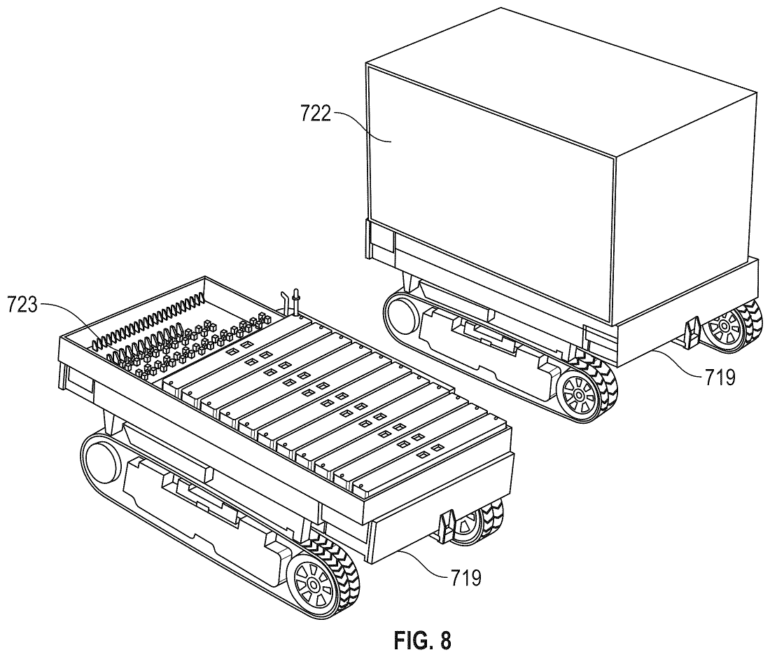

FIG. 8 is an isometric view of two mule robots 719, one loaded with a pallet of mounting components 723 and one loaded with a pallet of solar modules 722, representing one example embodiment of the present invention. Once a pallet of solar modules 722 or a pallet of mounting components 723 has been loaded onto the bed of the mule robot 719, such as with a forklift, one or more extendable cargo walls 721 may be folded up or laterally traversed, or both, to secure the pallet from dislodging during movement of the mule robot 719. In other example embodiments, a plurality of conveyor tracks or treads may be disposed in the bed of the mule robot 719 to laterally traverse a pallet of solar modules 722 or a pallet of mounting components 723 or other cargo into or out of the mule robot 719, such as onto a loading platform. The conveyor tracks themselves may laterally traverse a track past the side edge of the mule robot 719 in order to reach under cargo that is positioned on a trailer, a forklift, or other loading station. In this way, the mule robot 719 can be configured to autonomously load and unload a pallet of solar modules 722 and a pallet of mounting components 723 from a trailer, truck, docking station, loading station, loading platform, or other similar staging area.

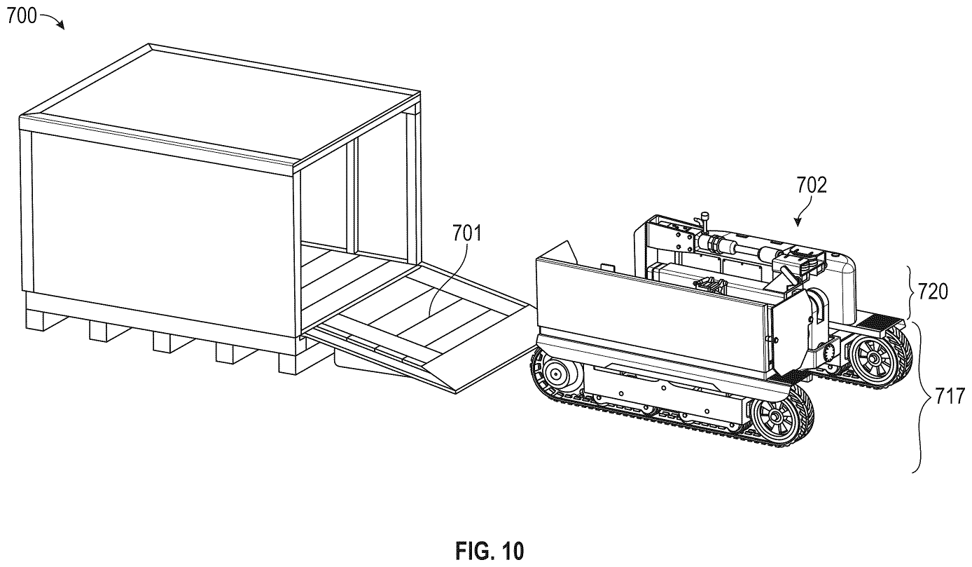

FIGS. 9 and 10 are isometric views of a crate 700 and a micropile robot 702. In FIG. 9, the crate 700 may be configured with one or more crate doors 701 on one side, and the crate 700 may have a X, Y, and Z dimensions. In some example embodiments, either the Y dimension or the Z dimension may be less than or equal to 86 inches, or the maximum width to fit through the doorway of a standard 40-foot high cube intermodal container. With a micropile robot or a mule robot loaded into a crate 700, the combined weight of the crate and one of the robots inside may be less than 3000 pounds. The crate 700 may have one or more apertures or clearances on its underside configured to receive the forks of a forklift for transport out of a shipping container.

FIG. 10 depicts an isometric view of a crate 700 with the crate door 701 folded down and a micropile robot 702 traversed out of the crate 700 and onto terrain 190. The micropile robot 702 is in a collapsed position in order to fit inside the crate 700. The crate door 701 may be configured to support the weight, pressures, and dimensions of the treads 704 for repeated use without yielding. FIGS. 2 and 6 show how the micropile robot 702 and mule robot 719 respectively would be configured in a similar fashion to enable transport within the crate 700.

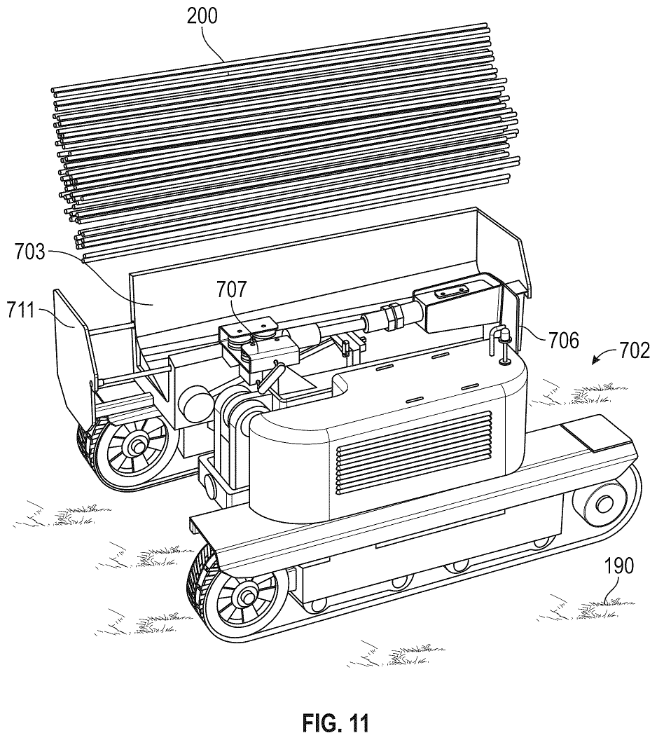

FIG. 11 is an isometric view of a micropile robot 702 with a plurality of micropiles 200 being placed into the micropile hopper 703. Micropiles may be cylindrical in shape and between 0.5 to 2.0 inches in diameter. In some examples, micropiles may be solid steel with ridges disposed on the outside surface, such as rebar. In other examples, micropiles may be hollow steel tubes. Micropiles may have a corrosion protection coating on their outside surface, such as one formed by galvanization, paint, epoxy, or other suitable coating.

At this stage, the micropile hopper retractable wall 711 has been deployed to extend the length of the micropile hopper 703 in order to fit the length of the micropiles 200. The retractable driving arm 706 may be in either a collapsed or an extended position when a plurality of micropiles 200 are placed in the micropile hopper 703. The micropile hopper 703 may be configured to retain between fifty and two-hundred-fifty micropiles 200. In some cases, the micropile hopper 703 may be configured to retain up to one-hundred-fifty micropiles 200. The location of the micropile hopper 703 and the power unit 705 on the chassis 717 may be such that the center of gravity is substantially aligned with the lengthwise centerline (parallel to the treads 704) when the micropile hopper 703 is retaining about half of the capacity of micropiles 200, such as when one hundred micropiles 200 remain in the micropile hopper 703.

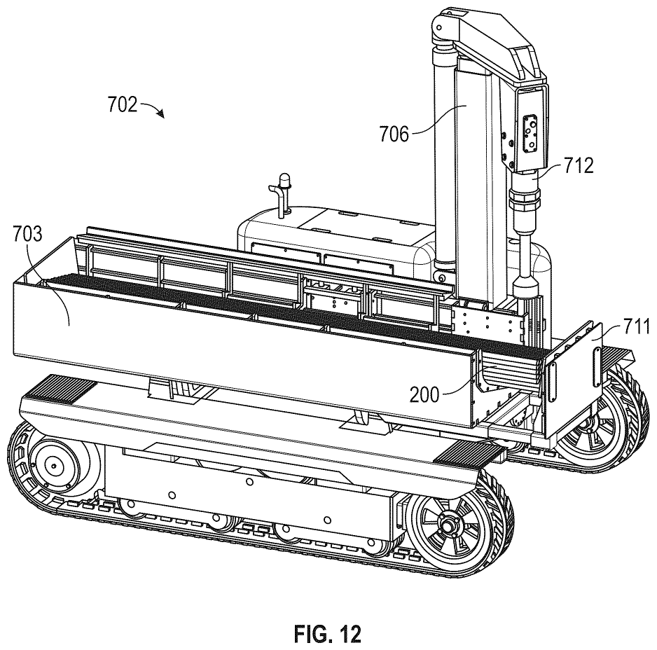

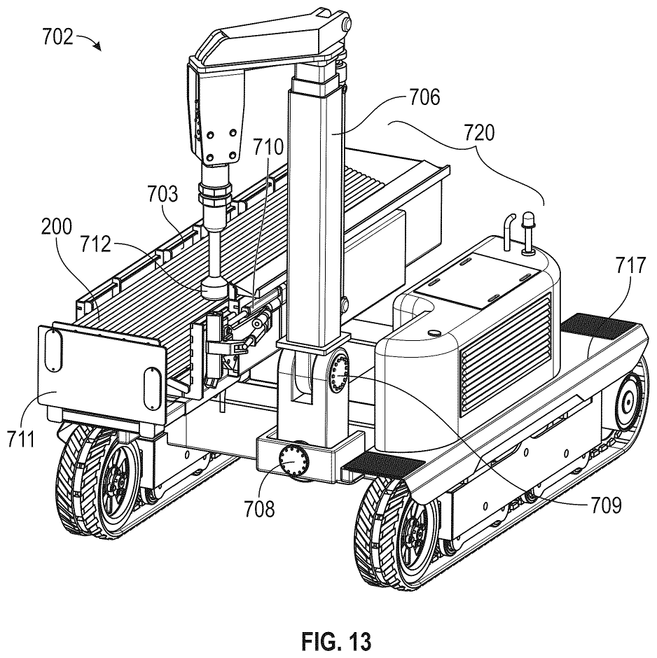

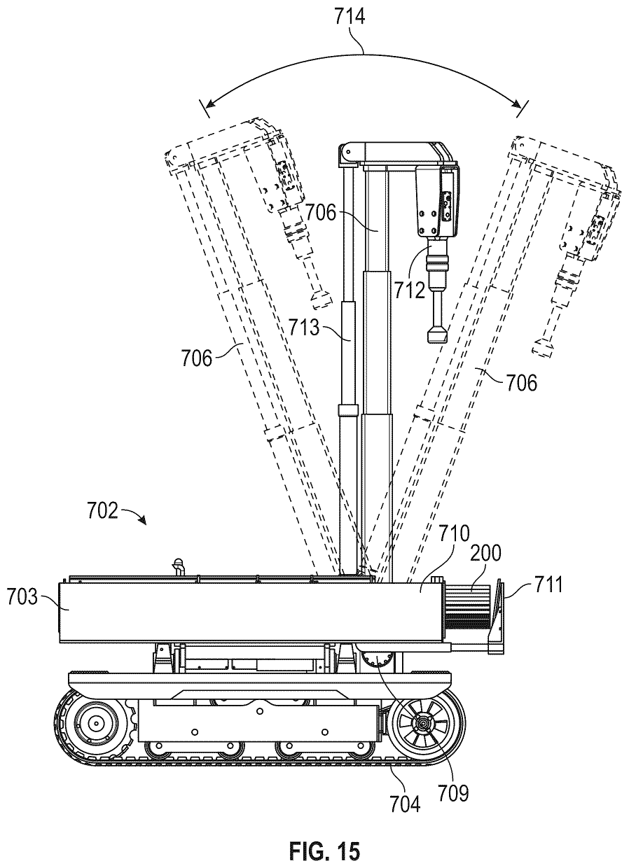

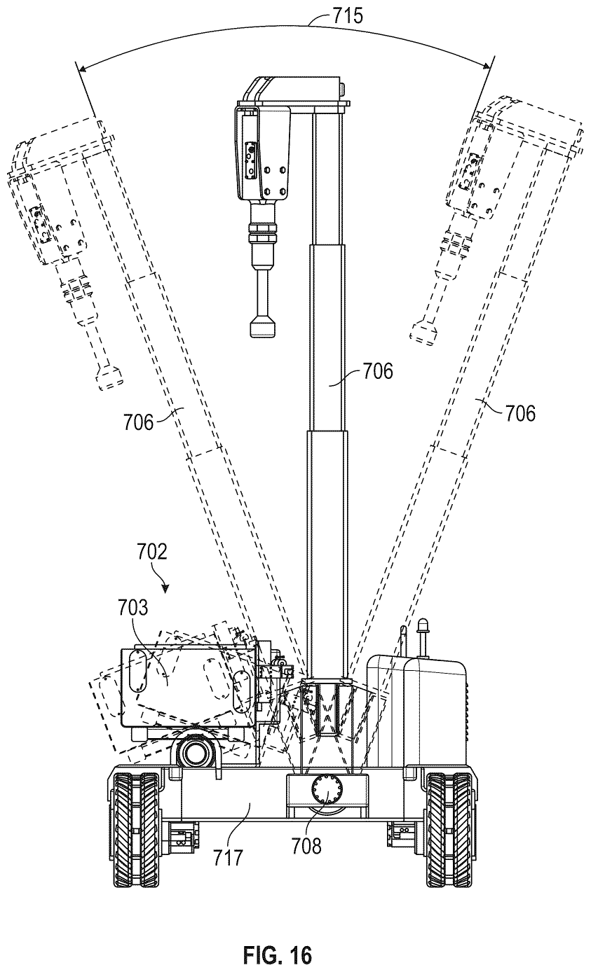

FIGS. 12 and 13 are isometric views of a micropile robot 702 with the micropile hopper 703 loaded with a plurality of micropiles 200 and the retractable driving arm 706 pivotally extended to a substantially vertical position around the longitudinal pivot 709 of the drive arm. In this view, the retractable driving arm 706 is not yet extended. The retractable driving arm 706 may have one or more telescoping or laterally sliding structural members to facilitate stowability, such as when in the crate 700, or it may be extended above a distal end of a micropile 200 (not shown) prior to being installed into the terrain 190. The retractable driving arm 706 may have one or more actuators or hydraulic or pneumatic pistons positioned adjacent to and configured to expand and collapse retractable driving arm 706 between a stowed position and an extended position. The retractable driving arm 706 may be attached to the chassis 717 by one or more articulating connections, such as drive arm lateral pivot 708 and a drive arm longitudinal pivot 709, so that the retractable driving arm 706 can be placed away from the perpendicular relative to the chassis, as shown in FIGS. 15 and 16. As depicted, the drive arm longitudinal pivot 709 may be attached to the retractable driving arm 706 on both sides to reduce or eliminate any moment forces on the bearing surfaces within the drive arm longitudinal pivot. Likewise, the drive arm lateral pivot 708 may be attached to both sides of the body below the drive arm longitudinal pivot 709 to reduce or eliminate any moment forces on the bearing surfaces within the drive arm lateral pivot. The drive arm lateral pivot 708 and the drive arm longitudinal pivot 709 may be powered by the power unit 705 using electricity or hydraulic forces to precisely articulate the retractable driving arm 706 in both of their respective axes.

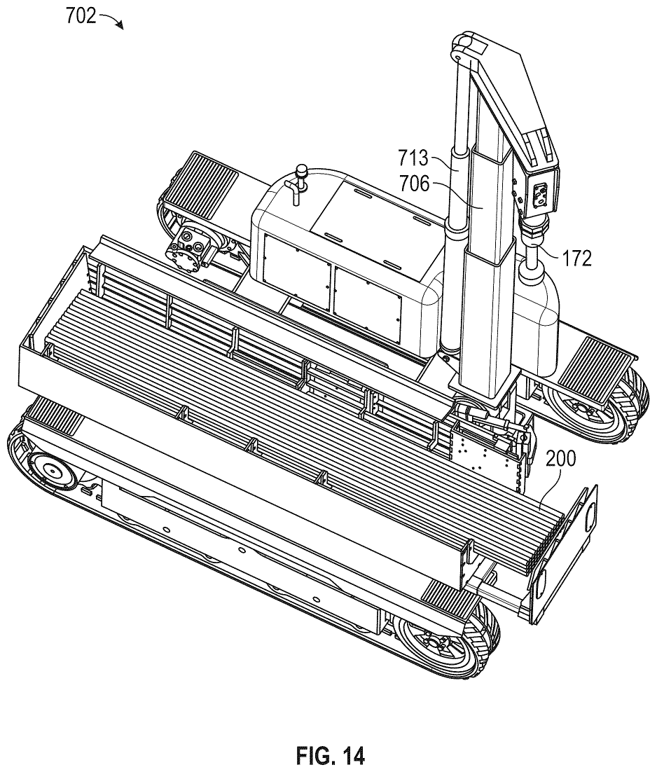

FIGS. 14 through 17 are isometric and plan views of a micropile robot 702 with a retractable driving arm 706 in an extended position, demonstrating the articulation ability of the retractable driving arm 706 through the drive arm lateral pivot 708 and the drive arm longitudinal pivot 709, representing one example embodiment of the present invention. In FIG. 14, the retractable driving arm 706 is extended using an extension actuator 713.

FIG. 15 is a side view of the micropile robot 702, depicting retractable driving arm 706 in a vertical position and pivoting through a range of drive arm longitudinal pivot angles 714 using the drive arm longitudinal pivot 709. Drive arm longitudinal pivot angle 714 may have a range from at least negative 10 to positive 10 degrees from the vertical, or in other examples from negative 30 to positive 30 degrees from the vertical.

FIG. 16 is an end view of the micropile robot 702, depicting retractable driving arm 706 in a vertical position and pivoting through a range of drive arm lateral pivot angles 715 using the drive arm lateral pivot 708. Drive arm lateral pivot angles 715 may have a range from at least negative 10 to positive 10 degrees from the vertical, or in other examples from negative 30 to positive 30 degrees from the vertical. The drive arm lateral pivot 708 and the drive arm longitudinal pivot 709 can be used simultaneously to position the retractable drive arm 706 up to 30 degrees from the vertical in both the X and Y directions, i.e., over a conical range of positions. This feature allows for micropiles 200 to be installed plumb with the center of the Earth when the micropile robot 702 is on a terrain 190 that is not perpendicular to the Earth center, such as on a hillside. In other words, the micropile robot 702 is configured to install a micropile 200 in a vertical position relative to gravity or to the earth center when the terrain 190 is at an angle 30 degrees or less from the horizontal (i.e. at 60 degrees or more from plumb). As shown, micropile hopper 703 may also be pivotally attached to chassis 717 and may pivot in synchronization to the pivoting of retractable drive arm 706. Micropile hopper 703 may pivot laterally through a same range of drive arm lateral pivot angles 715.

The retractable driving arm 706 and the connection to the chassis 717 may be such that the retractable driving arm 706 is near aligned with, or beyond a distal end of, the treads 704. The retractable driving arm 706 may be positioned along the Y axis within the chassis 717 to be near the center of gravity of the micropile robot 702 in order to minimize lifting or tipping of the micropile robot 702 when the micropile drive unit 712 is pushing a micropile 200 into the terrain 190.

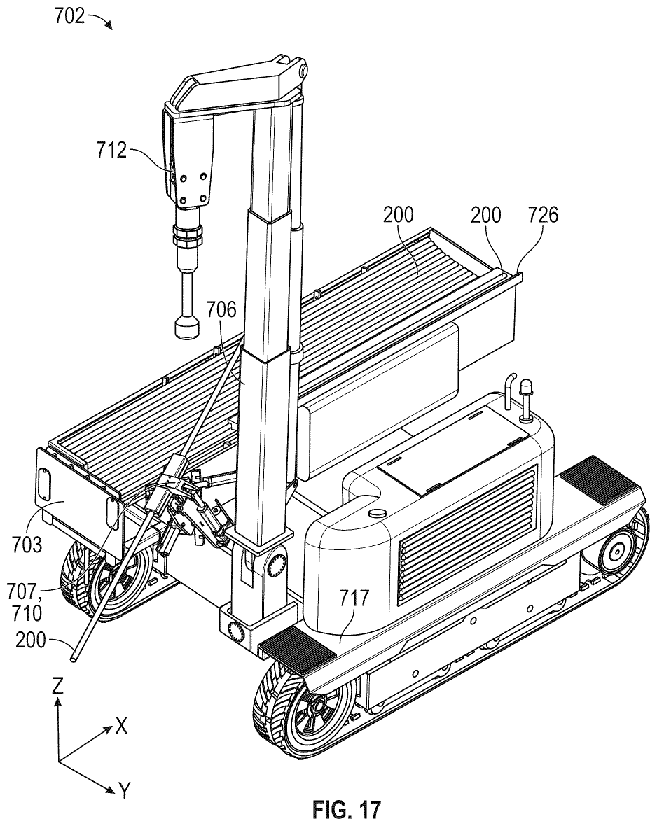

FIG. 17 is an isometric view of a micropile robot 702 where a micropile feeder 710 has grasped a micropile 200 from loading tray 726 and begun to pivot micropile from a horizontal orientation to a vertical orientation. In the example embodiments shown in FIGS. 12 through 18, micropile drive unit 712 may be offset diagonally from retractable driving arm such that the micropile drive unit 712 is aligned with the plane that the micropile feeder 710 rotates a micropile from a horizontal position to a vertical position. In other words, the micropile feeder 710 may only pivot within a single plane, traversing a micropile from a loading tray 726 or nearby horizontal resting location, up to a vertical position directly under the micropile drive unit 712. In this way, once the micropile feeder 710 has pivoted micropile 200 to a vertical position, micropile 200 may already be positioned directly under micropile drive unit 712. Micropile feeder 710 may have a pivot range from below a horizontal plane, such as negative ten degrees (to allow for pivoting below the loading tray 726) and then up to a positive angle that correlates to the maximum drive arm longitudinal pivot angle 714. For example, micropile feeder 710 may have a pivot range from negative ten degrees (below the horizontal) to positive one-hundred-twenty degrees, thus matching a maximum drive arm longitudinal pivot angle 714 of positive thirty degrees from vertical. Likewise, micropile feeder 710 may pivot laterally, either independently or directly with a lateral pivoting of the micropile hopper 703, as shown in FIG. 16. Thus, micropile feeder 710, and the micropile 200 it may be grasping, are able to pivot laterally through a range of range of drive arm lateral pivot angles 715 to correspond to the angle that retractable drive arm 706 is positioned.

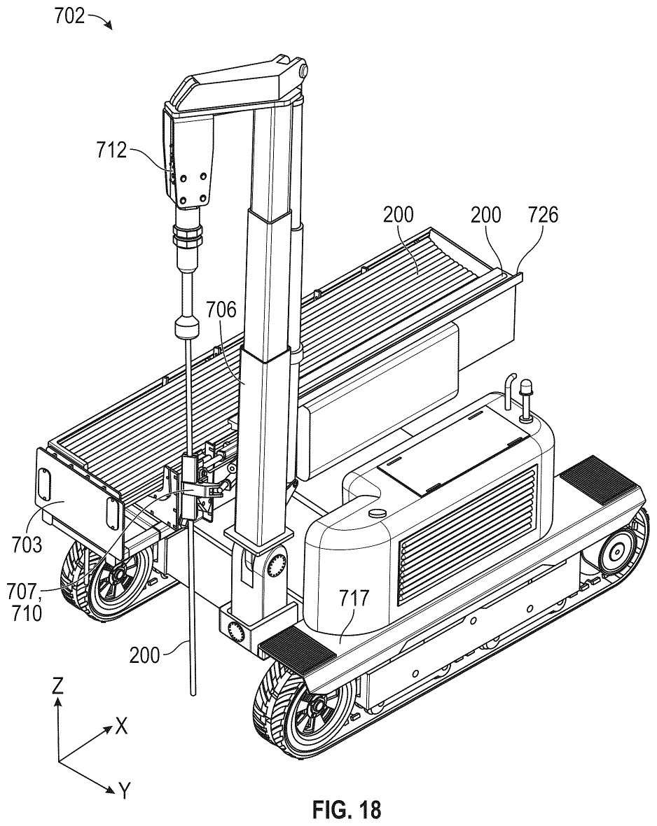

The micropile feeder 710 may be configured to grasp, retain and traverse one micropile 200 from the micropile hopper 703 to position the micropile under micropile drive unit 712. The micropile hopper 703 may have one or more steps, prongs, flanges, or other suitable devices to lift one micropile 200 out of the plurality of micropiles 200 in the micropile hopper 703 and into a position for the micropile feeder 710 to easily grasp onto. The micropile guide 707 may have one or more rollers, slides, bearings, guides, collars, or other suitable components to retain a micropile 200 at its opposite end or at a location on its mid-body so that the micropile is substantially aligned with the micropile drive unit 712, as described in more detail in the discussion below of FIGS. 18-20.

FIG. 18 is an isometric view of a micropile robot 702 where a micropile 200 is positioned into and held by the micropile guide 707 and the micropile drive unit 712. Micropile guide 707 may loosen its grasp sufficiently to allow micropile 200 to fall onto the terrain by gravity, while the guide still retains the micropile in a vertical position. Micropile drive unit 712 may then travers vertically down to engage and retain the skyward distal end of micropile 200 in preparation for driving the micropile into the terrain.

After the micropile 200 has been removed from loading tray 726 by micropile feeder 710, a next micropile 200 may be lifted out of the micropile hopper 703 and positioned on the loading tray 726, ready and positioned for pick-up by the micropile feeder 710. One or more recesses or notches may be in the side wall of the micropile hopper 703 or loading tray 726 to enable the micropile feeder 710 to grasp a micropile 200 that is resting on a loading tray 726.

One or more micropile guide 716, or bearings, slides, bushings, or similar devices, may traverse to substantially secure the micropile 200 in the X and Y directions while allowing the micropile 200 to readily traverse in the Z direction. The micropile guide 707 may be positioned such that when a lower distal end of the micropile 200 first makes contact with the terrain 190, the micropile guide 707 is positioned in the middle 50% length of the micropile 200. For example, for a solar module array 100 inches long, the micropile guide 707 would be positioned between 25 and 75 inches along the length of the micropile 200. The micropile guide 707 may also be positioned along the length of the micropile such that the micropile is sufficiently constrained from buckling or permanently yielding along its middle 50% section when the micropile drive unit 712 installs the micropile into the terrain. This position may be calculated considering a micropile 200 made of mild steel and 15 millimeters in diameter where the micropile drive unit 712 pushes down with up to 1000 Newtons of force or pushes up with up to 500 Joules of percussive energy.

The micropile drive unit 712 may be configured to rotate a micropile at high revolution speed, such as between 100 and 1000 revolutions per minute, while the extension actuator 713 pulls down the micropile drive unit 712 to drive a micropile into the terrain. The micropile drive unit 712 may also be configured to percussively impart force, such as by a hammer, a pile driver, or a piston, with the force applied and released in a magnitude and frequency to push a micropile into the terrain on each successive force application depending on the resistive force of the terrain. For example, the micropile drive unit 712 may cyclically apply up to 2000 newtons of force, or up to 500 joules, onto the micropile 200 at a frequency of 40 to 1500 impacts, strokes, or applications per minute. The micropile drive unit 712 may also be configured to both rotate a micropile and provide percussive force simultaneously. The micropile drive unit 712 may have an aperture on its underside configured to receive the distal end of the micropile, and may or may not have one or more grip pieces to retain the micropile upon insertion into the micropile drive unit.

In other example embodiments not shown, a drilling bit that is configured to cut through soil and rock may be mounted to an actuator arm that is in turn mounted to the micropile robot. In instances where the terrain is too firm or dense for the micropile to be installed with the micropile drive unit, the actuator arm may position the drill bit under the micropile drive unit 712. The micropile drive unit 712 may then rotationally and percussively drill the terrain to create a vacancy, hole, aperture, or pilot hole in the terrain. After the drill bit sufficiently drills a hole in the terrain, the retractable driving arm 706 may then extend back up, causing the actuator arm to retrieve and remove the drill bit from under the micropile drive unit 712 and back into a stowed position. A micropile 200 is then loaded under the micropile drive unit 712 and driven into the pilot hole formed from the drill bit. In some example embodiments, the drill bit may form a hole different than the diameter of micropile 200, such as −50% to +25% of the diameter of the micropile to enable the micropile drive unit to install a micropile into terrain.

In the example embodiment shown in FIGS. 12 through 18, the micropile guide 707 is integrated with the micropile feeder 710. In this configuration, the micropile feeder may pivot conically around a vertical axis in coordination with the pivoting of the retractable drive arm 706 such that the micropile 200 will be parallel to the retractable drive arm 706. In some example embodiments, the micropile guide 707 may be attached to the retractable driving arm 706 above the drive arm lateral pivot 708 and the drive arm longitudinal pivot 709 (see FIG. 11) such that the micropile guide 707 is always aligned with the micropile drive unit 712 at any drive arm lateral pivot angle 714 and drive arm longitudinal pivot angle 715.

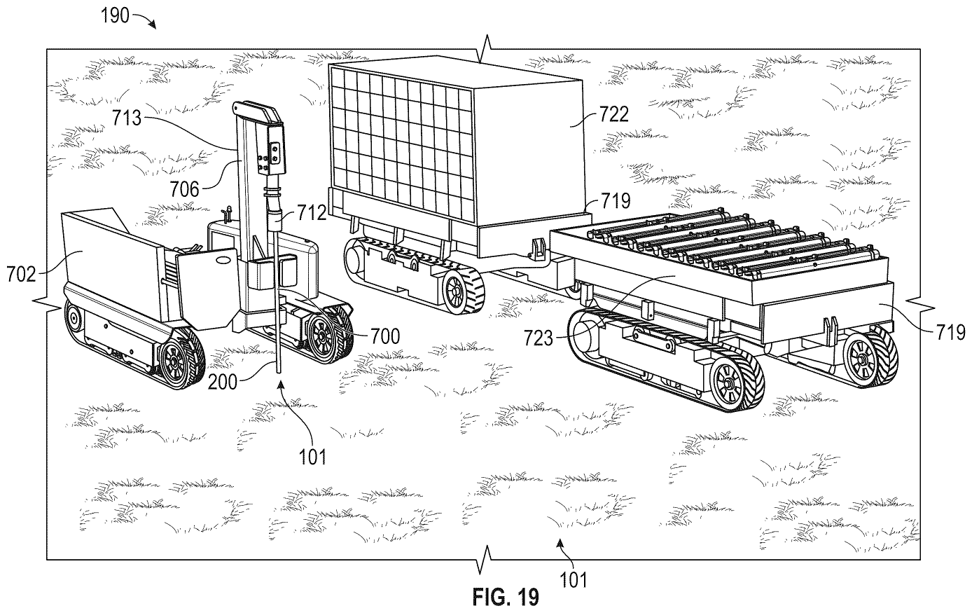

FIGS. 19 through 21 are isometric views of the installation sequence of a first short micropile column 101, representing one example of an installation method of the present invention. As depicted in FIG. 19, the micropile robot 702 is on the terrain 190 and has partially installed a first micropile 200 into the terrain using the micropile drive unit 712. The retractable driving arm 706 may be articulated to be parallel with gravity (i.e. vertical to earth center) so that the micropile is installed substantially vertical. Prior to beginning installation of a first micropile in a first short micropile column, a set of coordinates of installation locations for a plurality of micropiles, such as latitude, longitude, elevation, angle of ground, and known obstructions, may have been communicated to the micropile robot 702. The coordinates may include the elevation of the terrain as well as the desired reveal of each micropile at the corresponding latitude and longitude. In some examples, the reveal (height) of the micropile above the terrain may be chosen such that the exposed, skyward distal ends of each micropile within a short micropile column 101 or a tall micropile column 102 are substantially coplanar, such as within +/−100 millimeters, of the plane defined by the exposed distal ends of a first micropile 200 and a last micropile 200 within a column of micropiles. In this case, if the terrain is undulating or uneven, a micropile may be driven a different depth into the terrain so that the exposed distal ends of the micropiles within a short micropile column 101 or a tall micropile column 102 are substantially coplanar, such as within +/−100 millimeters of one another.

Micropile robot 702 may have traversed on the terrain 190 to position the micropile drive unit 712 and a first micropile 200 to be within a one-hundred-millimeter radius of a first coordinate. A first micropile 200 may be loaded from the micropile hopper 703 into the micropile drive unit 712 and the micropile guide 707 using a micropile feeder 710, then the micropile guide 716 may traverse to engage a first micropile, as previously described in FIGS. 17 and 18. In some embodiments, the micropile drive unit 712 may also engage the micropile so that the micropile is either suspended above the terrain, or so that the distal end of the micropile coincides with the terrain. The micropile feeder 710 may then release the micropile and retract out of the way, in some cases back to a lowered position. The retractable driving arm 706 may be articulated using the drive arm lateral pivot 708 and the drive arm longitudinal pivot 709 until the retractable driving arm 706 is substantially parallel with gravity. The extension actuator 713 may then retract until the distal end of the first micropile coincides with the terrain or it may continue to retract to drive the micropile into the terrain until it encounters a resistive force. The micropile drive unit 712 may then rotate, induce a percussive force, or both, as previously described, in coordination with the retraction of the extension actuator 713, to drive the micropile into the terrain to a desired depth, or until the micropile is exposed above the surface of terrain by a desired distance. In some example embodiments, a first micropile 200 may be installed into the terrain until the top distal end of the first micropile is between ten and seventy-five inches above the surface of the terrain, or in other cases between twenty and forty-five inches above the surface of the terrain.

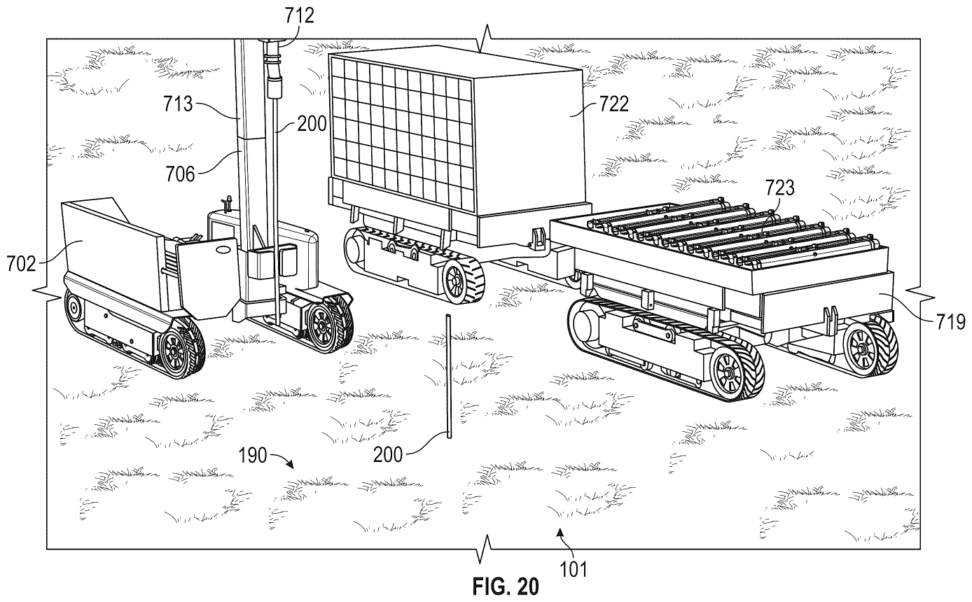

After the first micropile is installed to the desired depth, the extension actuator 713 may be extended to lift the micropile drive unit 712 off of the first micropile and up to a height ready to receive a second micropile. The micropile drive unit 712 may also then be articulated to be perpendicular to the chassis 717 in preparation for loading a second micropile using the drive arm lateral pivot 708 and the drive arm longitudinal pivot 709, as depicted in FIGS. 15 and 16. As shown in FIG. 20, the micropile robot 702 may traverse forward, using the treads 704, away from the first installed micropile until the micropile the drive unit 712 is positioned within a one-hundred-millimeter radius of the programmed coordinates of a second micropile 200. The sequence of loading the second micropile into a micropile drive unit 712 and installing the second micropile into the terrain are the same as those described above for the first micropile. The time required to traverse the micropile robot 702, to load the second micropile, and install the second micropile into the terrain can be reduced by loading the second micropile into the micropile drive unit 712 while the micropile robot 702 is traversing across the terrain 190 from the first micropile coordinate to the second micropile coordinate. In this way, the second micropile will already be in position and ready to be driven into the terrain by the time that the micropile robot has reached the second coordinate.

In some example methods, after the micropile robot 702 has begun to traverse away from an installed micropile 200, a base plate 300 may be placed over and down the micropile until the plate contacts the terrain 190. The base plate may be rotated around the axis of the micropile until the plate is substantially aligned with the closest horizontal topographical plane. A flange or tube section on the base plate may then be crimped, secured, or fastened to the micropile, in some cases using the same tool as used on a crimp tube that secures the swivel bracket assemblies to the micropiles. Then, a first end swivel bracket assembly 450 may be placed onto the distal end of the first micropile, with the lower distal end of the swivel bracket levelling screw 403 resting on the exposed distal end of the micropile. In some example methods, the crimp tube 402 on this first end-swivel bracket assembly 450 may be secured to this first micropile using a crimp or other suitable connection method.

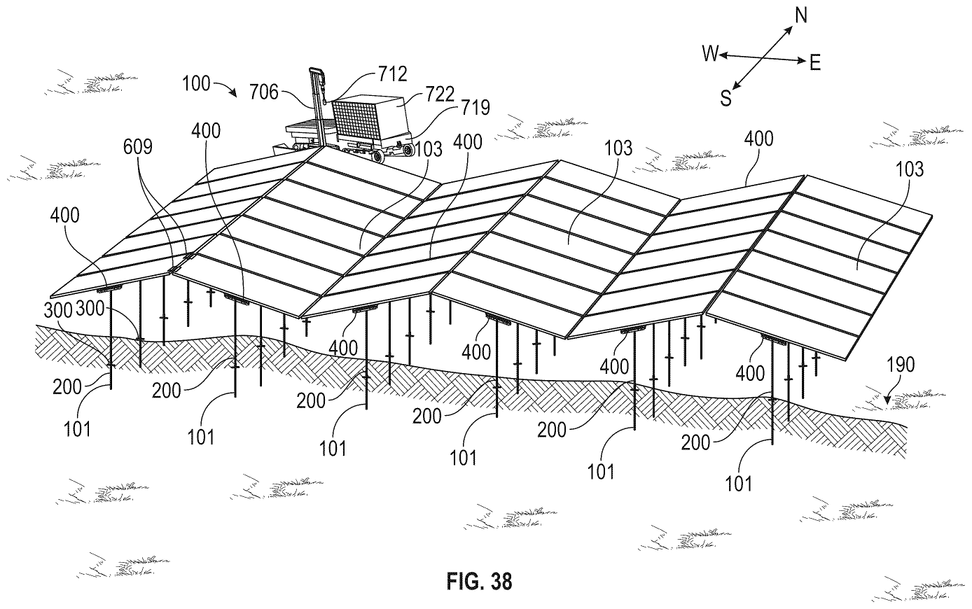

In other example embodiments and methods, the swivel bracket assembly may not have a levelling screw, wherein the swivel bracket assemblies are held to a desired height prior to being crimped to a micropile. In other examples depicted in FIG. 38, the mid-swivel brackets are installed on all micropiles, and adjacent columns of micropiles may be installed such that their skyward distal ends are coplanar within one-hundred millimeters of one another.

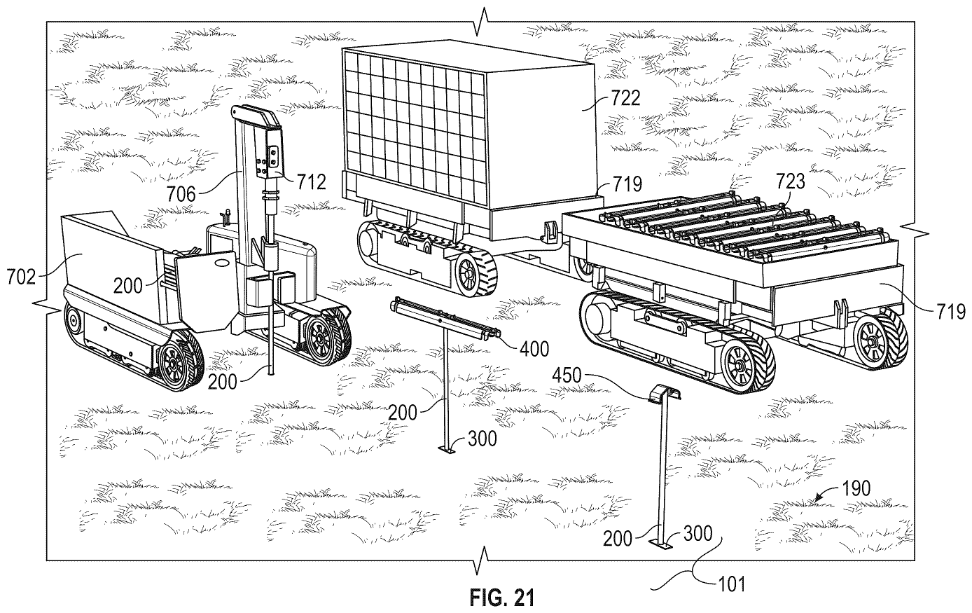

FIG. 21 depicts a micropile robot 702 installing a third micropile 200 in a first short micropile column 101, where the third micropile 200 is fully or nearly installed to the programmed reveal specific to that third micropile 200. In this stage, a second base plate 300 may have been installed and secured to a second micropile 200 in the same manner previously described, and a first mid-swivel bracket assembly 400 is placed onto a second micropile 200. At this point, the crimp tube 402 has not been secured to the second micropile 200, and the mid-swivel bracket assembly 400 is resting on the exposed distal end of the second micropile 200. One or more mule robots 719 carrying a pallet of solar modules 722 and a pallet of mounting components 723 may traverse across the terrain along with the micropile robot 702. In this way, a plurality of base plates 300, mid-swivel bracket assemblies 400, and end-swivel bracket assemblies 450 may be readily available and positioned near (such as within 5 meters) of the most recently installed micropile. In other example embodiments, an array may not use any base plates 300.

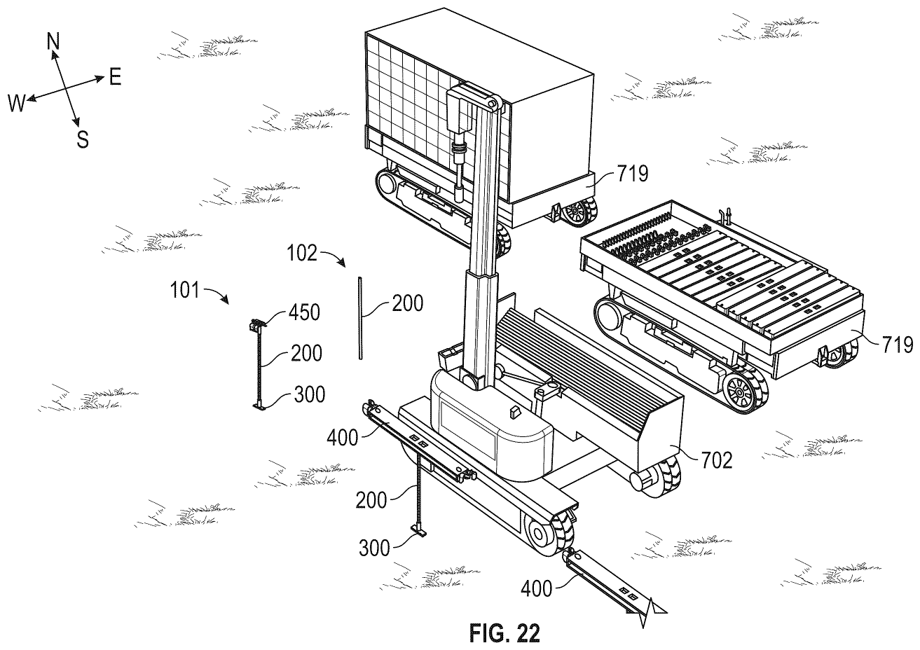

FIG. 22 is an isometric view of a far end of a first short micropile column 101 in which all micropiles may have a base plate 300 and either a mid-swivel bracket assembly 400 or an end-swivel bracket assembly 450 placed onto the exposed distal end of a respective micropile 200. The micropile robot 702 has turned substantially around (such as 180 degrees) and has installed a first micropile in a first tall micropile column 102 and is traversing to the location for installing a second micropile in the first tall micropile column 102. As an example, this end of the solar module array 100 may be substantially the northernmost end or the southernmost end. In other example embodiments, the distal ends of the micropiles in the first and second micropile columns are substantially coplanar. One or more mule robots 719 have been re-oriented further east so that they are relatively the same lateral distance away from the micropile robot 702.

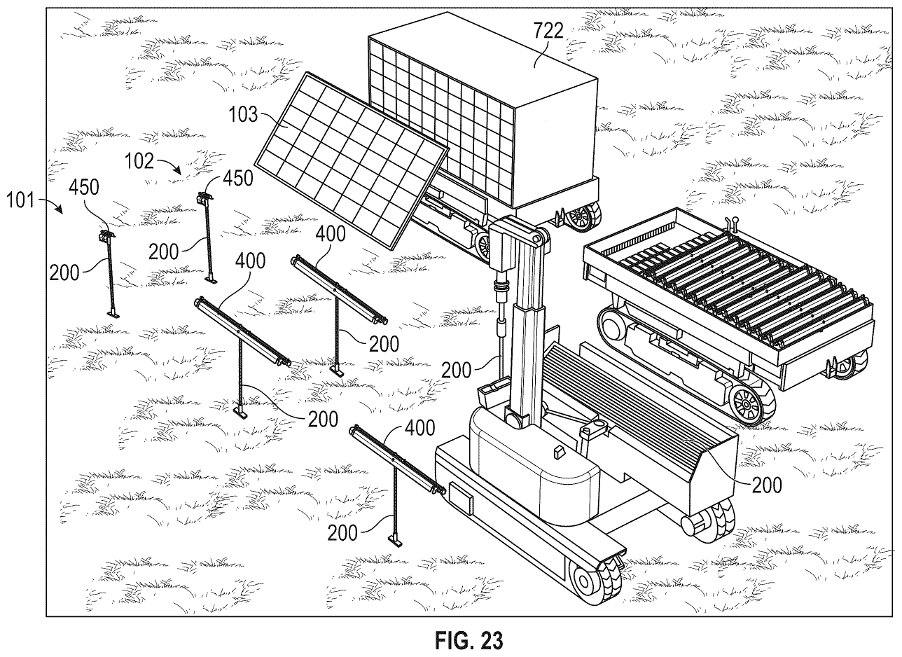

FIG. 23 may be a next step after a first end-swivel bracket assembly 450 and first mid-swivel bracket assembly 400 have been placed onto first and second micropiles, respectively, in a tall micropile column 102, respectively. As shown, a first solar module 103 is being moved from a pallet of solar modules 722 and placed over the two end-swivel bracket assemblies 450 and two mid-swivel bracket assemblies 400 on the short micropile column 101 and the tall micropile column 102. The solar module 103 may be moved by manual labor or by a robotic arm. In some example embodiments not shown, a robotic arm may be attached to a mule robot 719 that carries a pallet of solar modules 722, the robotic arm having one or more suction cups configured to grasp the main glass surface of the solar module 103. The robotic arm may then move the solar module precisely onto the two end-swivel bracket assemblies 450 and the two mid-swivel bracket assemblies 400, or it may position the solar module to within one meter of the location where it is to be installed. In this second example, one or more workers, humans, or humanoid robots may guide the solar module precisely to its final installation location with the robotic arm either detached or still attached.

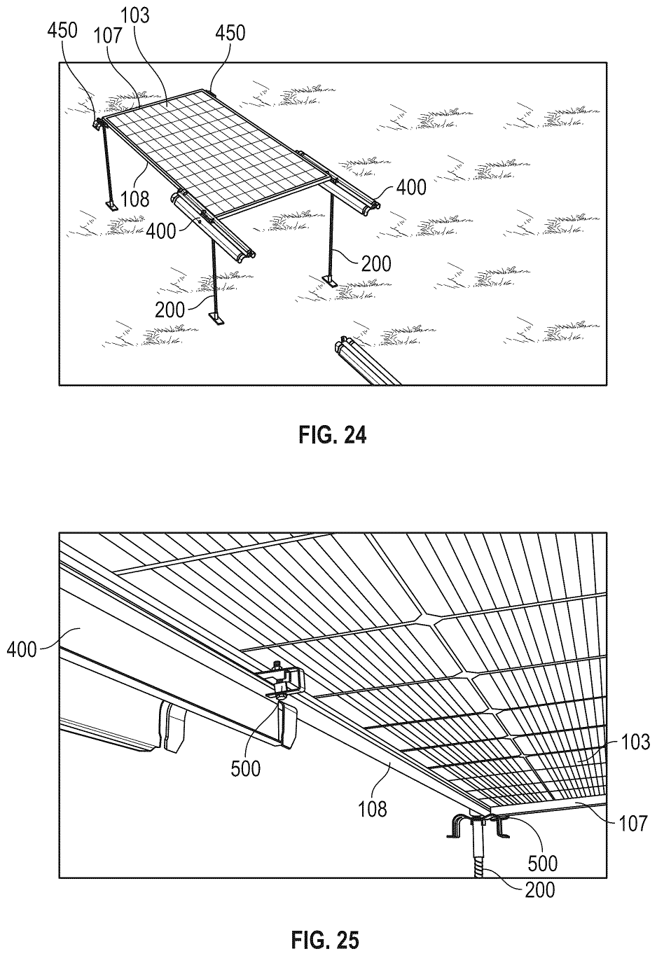

FIG. 24 is an isometric view from above of a first solar module 103 placed onto two end-swivel bracket assemblies 450 and two-mid swivel bracket assemblies 400. FIG. 25 is an underside isometric view of a first solar module 103, showing a module clamp 500 securing the solar module to each an end-swivel bracket assembly 450 and a mid-swivel bracket assembly 400. In some example embodiments, four module clamps 500 may secure one solar module 103 to two end-swivel bracket assemblies 450 and two mid-swivel bracket assemblies 400, or to four mid-swivel bracket assemblies 400. Once a module clamp 500 is installed to secure a solar module 103 to a mid-swivel bracket assembly 400 or an end-swivel bracket assembly 450, the module clamp 500 may create an electrical bond path between the solar module and the respective mid-swivel bracket assembly or end-swivel bracket assembly 450.

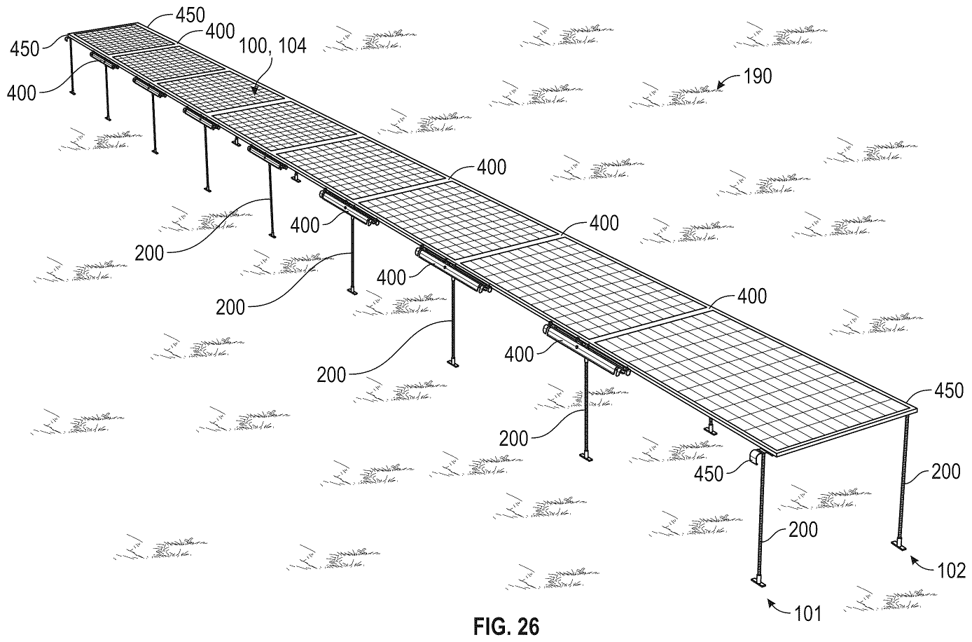

FIG. 26 is an isometric view of a plurality of solar modules configured as west-facing solar modules 104 on a first short micropile column 101 and a first tall micropile column 102. The one or more mid-swivel bracket assemblies 400 and end-swivel bracket assemblies 450 have not yet been secured or fastened to their respective micropiles.

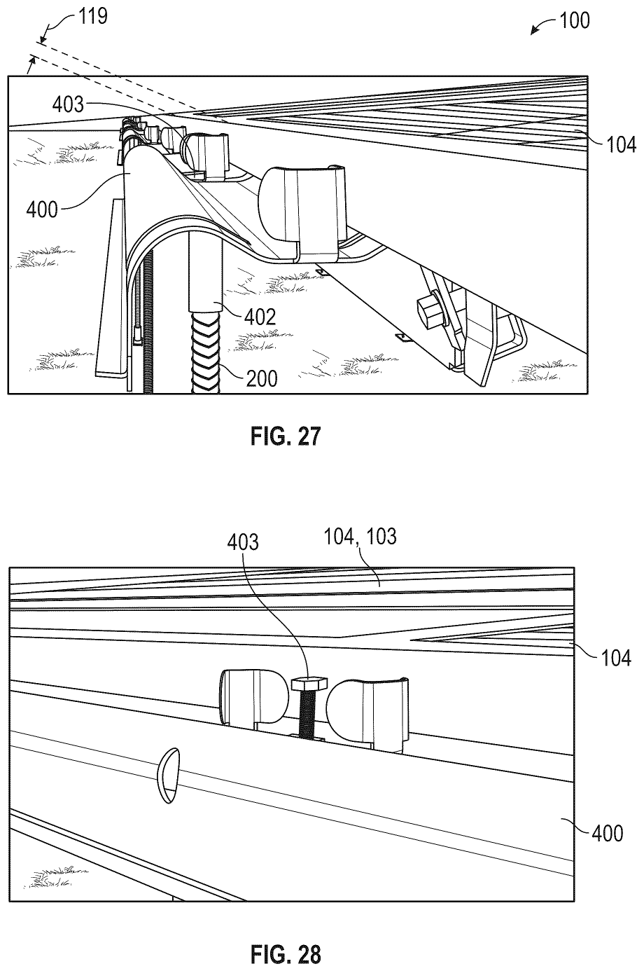

FIG. 27 is a view slightly offset from plan, taken along the edge of a plurality of solar modules 103 looking up a first short micropile column 101 or a tall micropile column 102. In this example, adjacent west-facing solar modules 104 may have a planar offset dimension 119 that is greater than zero due to the tolerance range of the reveal between each micropile in a short micropile column 101, as previously described for FIGS. 19-22.

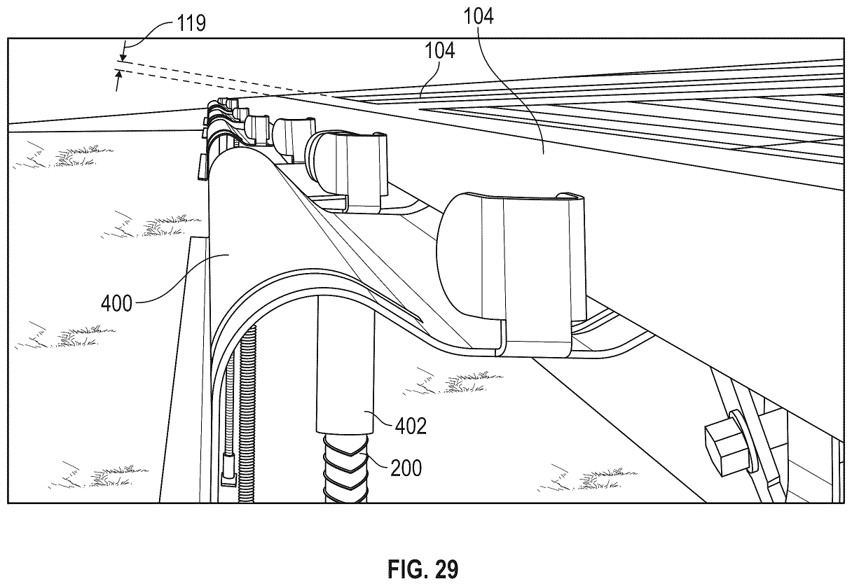

FIG. 28 is a side close-up view of FIG. 29 showing a swivel-bracket assembly with a levelling screw 403. The levelling screw 403 may be rotated with its distal lower end abutting the exposed distal upper end of a micropile 200. The levelling screw 403 may be threadably engaged with a crimp tube 402 to raise or lower the mid-swivel bracket assembly 400 or the end-swivel bracket assembly 450 and the solar module 103 supported by either bracket assembly to a different elevation. One or more threadably engaged levelling screws 403 in the short micropile column 101 or the tall micropile column 102 may thus be rotated to alter the elevation of their respective mid-swivel bracket assembly 400 or end-swivel bracket assembly 450 in order to reduce the planar offset dimension 119, the result shown in FIG. 29. In some example embodiments, the levelling screw 403 may be positioned substantially halfway down its threaded length into the threaded portion of the crimp tube so that the levelling screw can be rotated in either direction to raise or lower the mid-swivel bracket assembly 400 or the end-swivel bracket assembly 450. For example, the levelling screw 403 may be one-hundred millimeters long and set at approximately fifty millimeters below the lower surface of the crimp tube so that the mid-swivel bracket assembly 400 or end swivel bracket assembly 450 can be raised or lowered by fifty millimeters. In FIG. 29, the planar offset dimension 119 may be reduced such that each solar module 103 deviates in elevation between zero and twenty-five millimeters for every meter along the length of the short micropile column 101. In other examples, the planar offset dimension 119 may be reduced such that each solar module 103 deviates in elevation by less than ten millimeters for every meter along the length of the short micropile column.

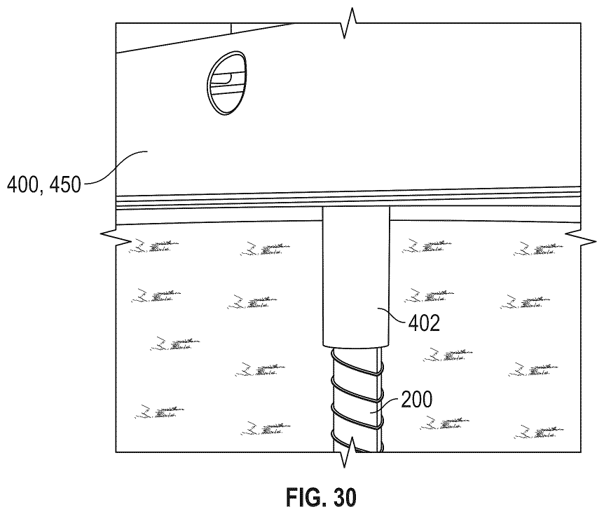

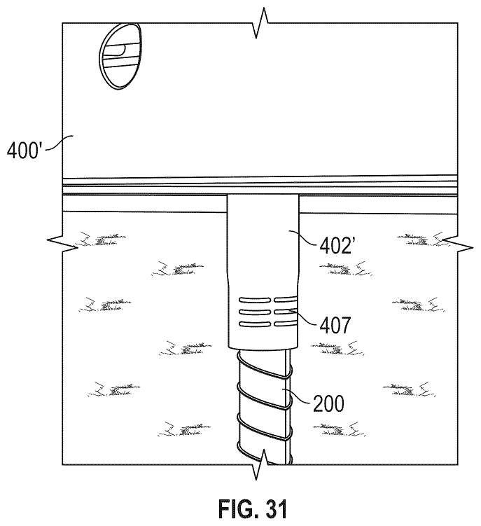

FIGS. 30 and 31 are side views of a crimp tube 402 on a micropile 200. Once a series of planar offset dimensions 119 have been reduced to desired levels, the crimp tube 402 may be secured to the micropile 200 through a crimp pattern using a crimping tool or through a series of clamping fasteners not depicted.

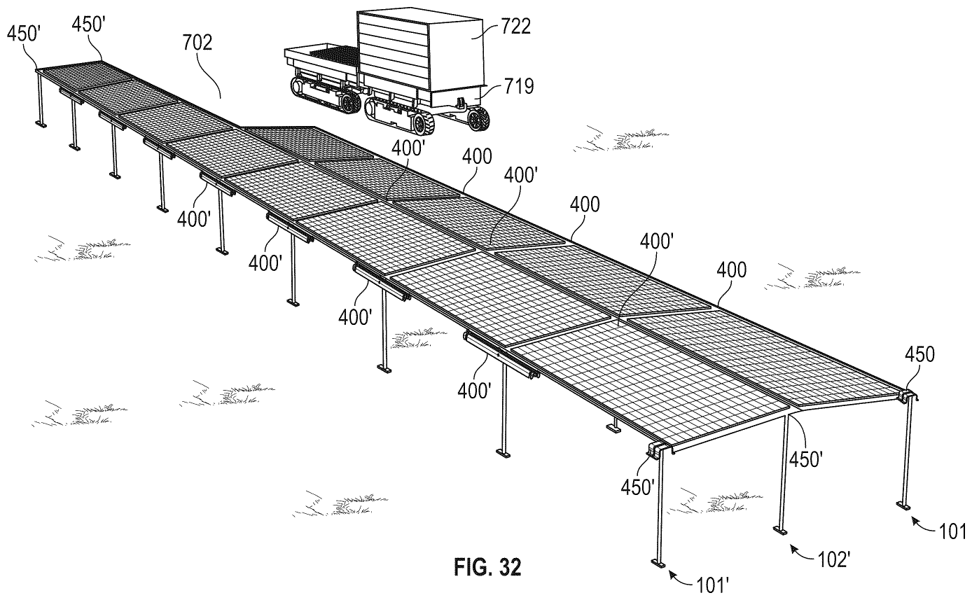

FIG. 32 is an isometric view depicting a next phase in the installation sequence. In this example, all mid-swivel bracket assemblies 400 and end-swivel bracket assemblies 450 within a first short micropile column 101 and a first tall micropile column 102 have been levelled as described in the discussion of FIGS. 27-29 above and are secured to their respective micropiles, as described in FIGS. 30-31. The columns are thereby configured as a bracket-assembly-bearing short micropile column 101′ and a bracket-assembly-bearing tall micropile column 102′. The micropile robot 702 may be in mid-process installing a second short micropile column 101 before, after, or during the transition of these columns to their bracket-assembly-bearing forms 101′ and 102′. A second column of solar module 103 may then be installed on the first tall micropile column 102′ and the second short micropile column 101, as depicted. Notably, the first tall micropile column 102 may be transitioned to the bracket-assembly-bearing tall micropile column 102′ while the second short micropile column 101 is being installed, but before the second column of solar modules 103 is installed.

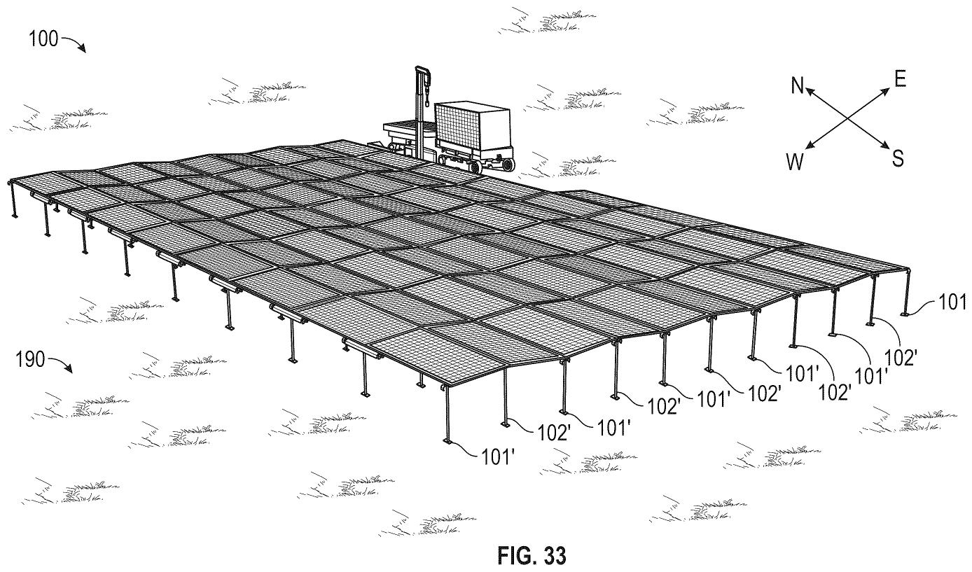

FIG. 33 is an isometric view of the solar module array 100 with additional columns of west-facing solar modules 104 and east-facing solar modules 105 installed. All short micropile columns 101 and tall micropile columns 102 may be transitioned to their bracket-assembly-bearing forms except for a last column being installed. A process may thus be followed wherein all installed short micropile columns 101 or tall micropile columns 102 are transitioned to their bracket-assembly-bearing forms 101′ and 102′ before, after, or while a subsequent short micropile column 101 or tall micropile column 102 is installed (whatever is next in the sequence), and before a subsequent column of solar modules is installed.

As a column of solar modules is being installed, adjacent solar modules in the column may be electrically connected to each another in electrical series where the voltage increases as more solar modules are connected. As an example depicted in FIG. 33, the farthest column of solar modules that is partially installed may be in the process of being electrically connected in series, and the nearest completed column of solar modules (the easternmost full column of solar modules) may be already electrically connected or in the process of being electrically connected.

In other example methods, micropile robot 702 may have installed all micropiles 200 within a solar module array 100 before swivel brackets or solar modules are installed. In this example method, once all of the micropiles have been installed into terrain for the solar array, which may occur on a first day or during the nighttime, then the process of installing swivel brackets and solar modules may commence as previously and subsequently described.

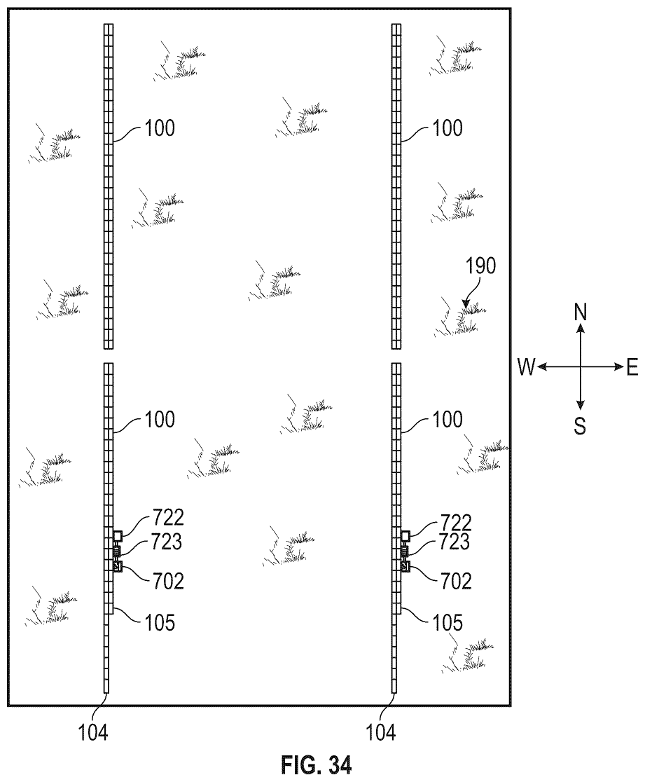

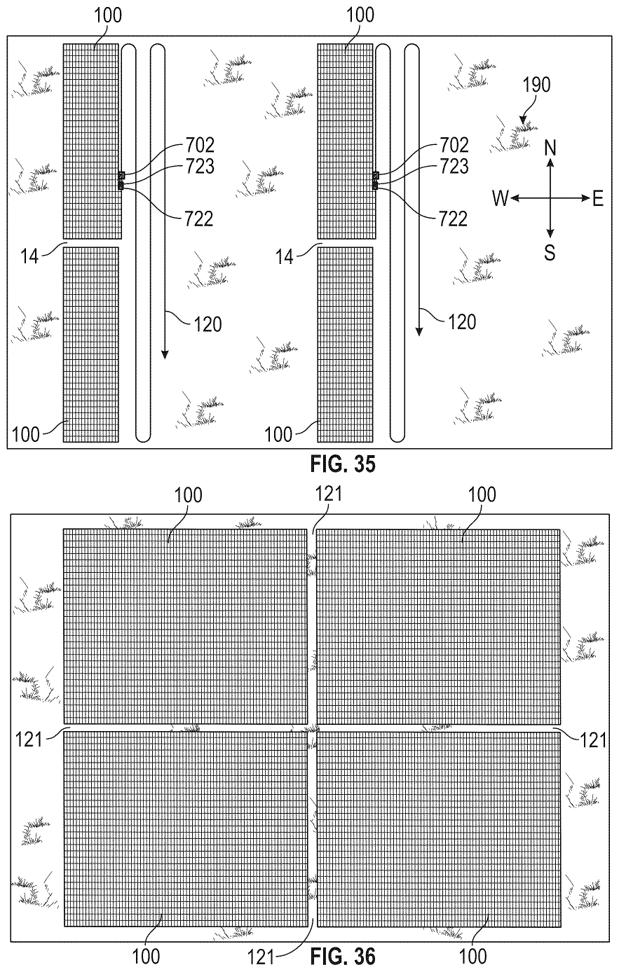

FIGS. 34 through 36 are top-down views of four solar module arrays at various stages of installation. In FIG. 34, a set of micropile robots 702 and mule robots 719 are traversing across the terrain 190 and constructing two solar module arrays. A micropile robot 702 is traversing in a substantially north-south direction to build each short micropile column 101 or tall micropile column 102 for the respective solar module array 100. In some examples, the micropile robot 702 may continue past the perimeter of the first solar module array to continue installing a short micropile column 101 or a tall micropile column 102 in a second solar module array. As depicted in FIG. 35, a micropile robot 702 may follow the micropile installation assembly 720 in a cyclical north, south, north, south, etc. path, moving east (as depicted) or west, as subsequent short micropile columns 101 and tall micropile columns 102 are installed and transitioned to their bracket-assembly-bearing forms 101′ and 102′, and the solar modules are installed and electrically connected. One or more mule robots 719 may move alongside the micropile installation assembly 720, as directed by a proximity constraint or an independent micropile installation assembly 720. The micropile installation assembly 720 may be pre-loaded into a computer on a micropile robot 702. Alternatively, the micropile installation assembly 720 may be wirelessly controlled on a regular cadence (such as every minute) or in real-time, or a combination of both. The micropile installation assembly 720 may be updated as one or more solar module arrays are being constructed, such as if an unanticipated obstruction in the path of the micropile installation assembly 720 is encountered. While a micropile robot 702, with or without a mule robot 719, is installing or constructing one or more solar module arrays, additional quantities of micropiles, pallets 722 of solar modules, and pallets 723 of mounting components may be staged along the micropile installation assembly 720 so that these parts can be replenished on the micropile robot 702 and mule robot 719 when the micropile hopper 703 or the pallet of solar modules or the pallet of mounting components on the mule robot becomes empty. In some cases, the pre-staged replenishment material may be staged at the turning point of the micropile installation assembly 720, for example at the south or north edge of a solar module array, or mid-way along the straight section of the micropile installation assembly.

FIG. 36 is a top-down view of four installed adjacent solar module arrays 100. An array aisle-way 121 separates each solar module array 100. The array aisle-way 121 may be five to fifty feet wide, and configured to readily allow a work vehicle, such as a standard pickup truck, to pass through. An array aisle-way in the north-south direction may be different in width than an array aisle-way along the east-west direction.

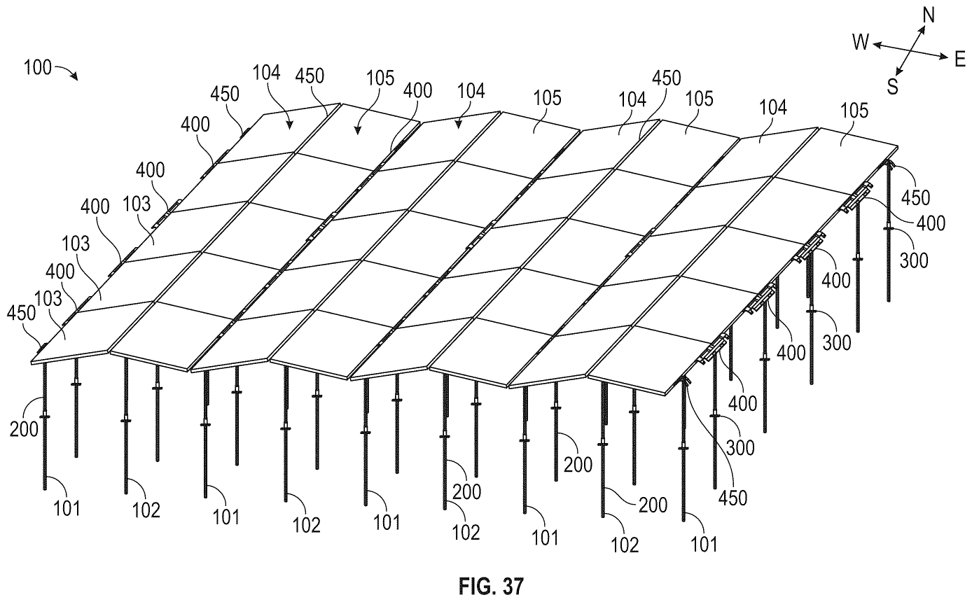

FIG. 37 is an isometric view of a solar module array 100. The array may consist of a plurality of micropiles 200 arranged in columns and rows, with a plurality of solar modules 103 connected to the micropiles 200 on mid-swivel bracket assemblies 400 and/or end-swivel bracket assemblies 450. A plurality of micropiles may be arranged in one or more short micropile columns 101 and tall micropile columns 102 as depicted, wherein each column is substantially aligned along a north-south direction. The plurality of solar modules 103 may be arranged in one or more columns of west-facing solar modules 104 and east-facing solar modules 105 wherein the columns are substantially aligned along a north-south direction. As depicted, columns of solar modules 103 may alternate between west-facing solar modules 104 and east-facing solar modules 105, but in other example embodiments, short micropile columns 101 and tall micropile columns 102 may be arranged so that a solar module array 100 has more than one column of west-facing solar module 104 adjacent to one or more columns of east-facing solar modules 105. Other example embodiments could include two or more columns of west-facing solar modules 104, followed by alternating columns of east-facing solar modules 105 and west-facing solar modules 104, followed by two or more columns of east-facing solar modules 105.

FIG. 38 depicts an alternative embodiment of a solar module array 100 wherein solar modules 103 are installed in a portrait orientation with their long edge 108 substantially aligned East-West. The example in FIG. 38 would be installed in substantially the same manner as depicted in FIG. 20 through 36, however with the solar modules 103 in a portrait orientation with each micropile column 101 aligned substantially with the centerline the solar modules 103 it supports. In this example embodiment micropile column 101 and micropile column 102 are installed to a substantially similar elevation, such as within one-hundred millimeters of one another when the terrain is flat. This embodiment also only uses mid-swivel brackets 400 in all locations. At least one module connector 609 may be installed at the corners of all adjacent solar modules 103 in peak and trough locations to structurally connect and electrically bond adjacent columns of solar modules 103. In this example, a first column of solar modules 103 may be installed on a first column of micropiles before the robot has begun installing a second column of micropiles. In other words, a method may be where a robot installs a first and second micropile 200 into terrain 190. Anytime after the first two micropiles are installed, mid-swivel brackets 400 may be installed onto the micropiles followed by installation of the solar modules 103 to the mid-swivel brackets. In this method, the robot may have traversed across terrain to install at least a third micropile in a first column of micropiles.

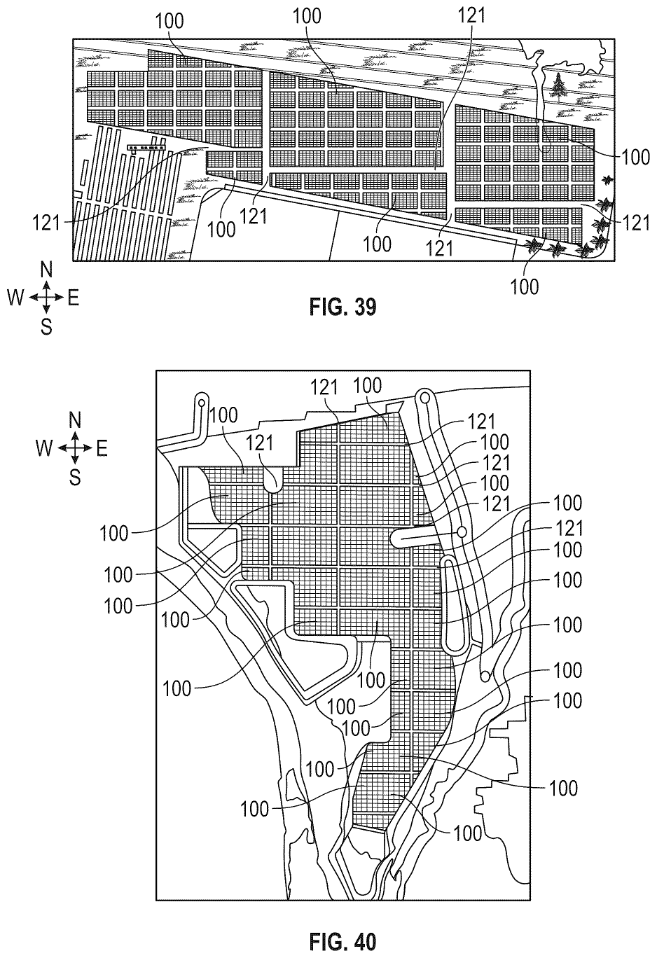

FIGS. 39 and 40 are top-down views of other arrangements of a plurality of solar module array 100, representing further example embodiments of the present invention. As shown in FIG. 39, one array aisle-way 121 may extend only the width of a contiguous solar module array 100, while an array aisle-way 121 between the next set of solar module arrays is offset. For example, the middle east-west array aisle-way is offset south of the west-most east-west oriented array aisle-way. FIG. 39 also depicts how the various columns and rows of solar modules within a solar module array may have different quantities of solar modules and may start or end along different latitudinal or longitudinal planes. For example, in FIG. 39, the northwesternmost solar module array 100 has a variable amount of solar modules in each column and in many rows. In FIG. 40, multiple solar module arrays are configured so that adjacent array aisle-ways 121 are coincident or aligned along latitudinal and longitudinal planes.

In some example embodiments, a solar module array may be configured with an equal number of columns of west-facing solar modules 104 and columns of east-facing solar modules 105, such that the west-most column consists of west-facing solar modules and the east-most column consists of east-facing solar modules. Each solar module 103 may have a maximum production voltage which is the maximum voltage that a single solar module 103 may produce, and each solar module may be rated to a maximum system voltage which is the maximum voltage capacity when a plurality of solar modules are connected electrically in series. A column of west-facing solar modules or east-facing solar modules may have a quantity of solar modules equal to or less than the maximum system voltage divided by the maximum production voltage. For example, if a solar module 103 has a maximum production voltage of 49.8 volts, and a maximum system voltage of one module lifter 500 volts, then one module lifter 500 divided by 49.8 volts equals 30.12, which rounds down to thirty solar modules electrically connected in series for a column of west-facing or east-facing solar modules. Columns of west-facing solar modules may be electrically connected in parallel to a first electrical inverter, thereby maintaining the total voltage of column of west-facing solar modules but increasing the amperage delivered to the first inverter. Likewise, column of east-facing solar modules may be electrically connected in parallel to a second electrical inverter, thereby maintaining the total voltage of each column of east-facing solar modules but increasing the amperage delivered to the second inverter. A solar module array 100 may have a quantity of columns of west-facing solar modules electrically connected in parallel to deliver a desired maximum amperage, which may be limited to the maximum amperage capacity of an inverter. In other example embodiments where the quantity of solar modules in a column of west-facing solar modules does not exceed the maximum system voltage of a solar module, a first column of west-facing solar modules may be electrically connected in series to a second column of west-facing solar modules. For example, using the previously stated voltage capacities, a first column of west-facing solar modules with fifteen solar modules may be electrically connected in series to a second column of west-facing solar modules with fifteen solar modules to maximize the potential voltage produced while not exceeding the maximum voltage capacity of a solar module.

Bifacial or monofacial solar modules may be used, the bifacial modules producing electricity from light incident on either the front or back surfaces of the solar module. Solar modules utilizing mono-crystalline, poly-crystalline, or thin-film photovoltaic technology may be used. Solar modules with aluminum frames pre-installed on all four sides of the photovoltaic laminate, or solar modules with no external frame that consist instead of from two sheets of glass laminated together encapsulating a plurality of photovoltaic cells or a deposition photovoltaic material, may be used.

In the figures presented herein, the solar laminate, glass, photovoltaic cells, or energy capture interface of any solar module may be hidden from view in order to better understand the present invention. Many of these figures show only the solar module frame array and the terrain clearance, but it should be understood that in all cases, it is conceived that each solar module would be a complete and operational solar energy collection device, such as a solar photovoltaic module. In all examples herein, the terrain may be undisturbed land, graded land, dirt, soil, grass, sand, rock, cobbles, landfills, compacted soils, farmland, fields, hills, ditches, knolls, potholes, the surface of a planet, the ground, or other installation surface.

What is claimed is:

1. A robotic system for driving micropiles into a terrain, the system comprising:
a chassis;
a micropile hopper mounted to the chassis;
a retractable driving arm of an extendable length, wherein the driving arm is mounted to the chassis by at least one articulating connection;
a drive unit mounted to the driving arm, wherein the drive unit drives a micropile into the terrain;
a micropile feeder that feeds the micropile from the micropile hopper to a position under the drive unit; and
a power unit that powers the drive unit and the driving arm.

2. The system of claim 1, wherein the micropile hopper retains 50 to 200 micropiles.

3. The system of claim 1, wherein the robotic system is collapsible to fit inside a crate that is less than 86 inches wide.

4. The system of claim 1, wherein the retractable driving arm includes a centerline, wherein the drive unit is positioned laterally to the centerline.

5. The system of claim 1, wherein the retractable driving arm is pivotally mounted to the chassis with a first pivot range of at least −10 to +10 degrees relative to a vertical.

6. The system of claim 5, wherein the retractable driving arm includes a second pivot range of at least −10 to +10 degrees relative to the vertical in an orthogonal orientation to a direction of the first pivot.

7. The system of claim 1, wherein the retractable driving arm is of telescopic construction, from a retracted length for stowing to an extended length for driving the micropile into the terrain.

8. The system of claim 1, wherein the drive unit is configured to apply compressive force to the micropile.

9. The system of claim 1, wherein the retractable driving arm, the drive unit, and the micropile feeder are configured to engage micropiles that are cylindrical and less than 2.0 inches in diameter.

10. The system of claim 1, further comprising one or more tracks on the chassis, the tracks configured to guide the robotic system over the terrain.

11. The system of claim 1, further comprising a micropile guide to secure the micropile against buckling as the micropile is being driven into the terrain.

12. A method for transporting a micropile by a robotic system, the method comprising:
drawing a horizontal stack of micropiles from a micropile hopper by a micropile feeder of the robotic system;
reorienting one of the micropiles from a horizontal position to a vertical position under a drive unit of the robotic system by the micropile feeder; and
driving the micropile in the vertical position into the terrain by the drive unit of the robotic system.

13. The method of claim 12, wherein the micropile hopper contains 50 to 200 micropiles.

14. The method of claim 12, wherein the robotic system is collapsible and is sized to fit inside a crate that is less than 86 inches wide.

15. The method of claim 12, wherein driving the micropile is performed by a retractable driving arm with a centerline and a drive unit that is positioned laterally relative to the centerline.

16. The method of claim 15, wherein the retractable driving arm is of telescopic construction, further comprising telescopically shortening the retractable driving arm before driving the micropile into the terrain.

17. The method of claim 12 wherein driving the micropile into the terrain is performed by a compressive force.

18. The method of claim 12, wherein the retractable driving arm, the drive unit, and the micropile feeder are configured to engage one or more micropiles that are cylindrical and less than 2.0 inches in diameter.

19. A method for transporting a plurality of micropiles by a robotic system, the method comprising:
drawing a first micropile from a plurality of micropiles in a micropile hopper by a micropile feeder;
transporting the first micropile to a first set of coordinates from among a preselected coordinates on a terrain;
driving the first micropile into the terrain using a retractable driving arm of the robotic system at the first set of coordinates to a depth such that an exposed distal end of the micropile is at a first elevation above the terrain;
transporting the micropile feeder back to the micropile hopper; and
traversing the robotic system across the terrain to a next set of coordinates.

20. The method of claim 19, further comprising:
drawing a second micropile from the micropile hopper by the micropile feeder;
transporting the second micropile to a second set of coordinates among the preselected coordinates on the terrain;
driving the second micropile into the terrain using the retractable driving arm of the robotic system at the second set of coordinates to form a column of micropiles with the first micropile, wherein distal ends of first micropile and the second micropile are coplanar.

21. The method of claim 20, wherein the distal ends of micropiles in the column are between 10 and 70 inches above the terrain.

22. The method of claim 19, wherein transporting the first micropile is performed such that each micropile is within a 100 mm radius of first set of coordinates.

23. The method of claim 19, wherein driving the first micropiles into the terrain includes driving the micropiles to different depths in the terrain, wherein a distal end of the first micropile and a distal end of a second micropile are within 100 mm of each other.

24. The method of claim 19, wherein driving the first micropile into the terrain is performed by a compressive force.

25. The method of claim 19, wherein driving the first micropile into the terrain is performed by percussive force.

26. The method of claim 19, wherein the retractable driving arm is pivotal around two orthogonal axes to enable the retractable driving arm to be oriented parallel to gravity.

27. The method of claim 19, wherein the retractable driving arm, the drive unit, and the micropile feeder are configured to engage micropiles that are cylindrical and less than 2.0 inches in diameter.
